(19) United States
(12) Patent Application Publication
(10) Pub. No.: US 2024/0333609 A1
(43) Pub. Date: Oct. 3, 2024

(54) APPARATUS AND METHOD FOR MEASURING AND MONITORING NETWORK SLICE PATH QUALITY IN A WIRELESS COMMUNICATION SYSTEM

(71) Applicant: Samsung Electronics Co., Ltd., Suwon-si (KR)

(72) Inventors: Jaijin LIM, Suwon-si (KR); Seungyoup HAN, Suwon-si (KR)

(21) Appl. No.: 18/741,010

(22) Filed: Jun. 12, 2024

Related U.S. Application Data
(63) Continuation of application No. PCT/KR2023/000762, filed on Jan. 17, 2023.

(30) Foreign Application Priority Data
Feb. 11, 2022 (KR) 10-2022-0018398

(51) Int. Cl. H04L 41/5009; H04W 24/08

(52) U.S. Cl. CPC H04L 41/5009; H04W 24/08

(57) ABSTRACT

A method performed by a central unit-user plane (CU-UP) in a wireless communication system is provided. The method includes receiving information related to packet transmission from a user plane function (UPF), the information related to the packet transmission including a quality of service (QoS) flow provided, a slice provided with the QoS flow, an indicator indicating a terminal for receiving the QoS flow and a time parameter related to latency quality measurement, identifying a quality measurement value based on the received information related to the packet transmission, updating the received information related to the packet transmission based on the identified quality measurement value, and transmitting the updated information related to the packet transmission to a distributed unit (DU).

### CROSS-REFERENCE TO RELATED APPLICATION(S)

This application is a continuation application, claiming priority under § 365(c), of an International application No. PCT/KR2023/000762, filed on Jan. 17, 2023, which is based on and claims the benefit of a Korean patent application number 10-2022-0018398, filed on Feb. 11, 2022, in the Korean Intellectual Property Office, the disclosure of which is incorporated by reference herein in its entirety.

### BACKGROUND

### 1. Field

The disclosure relates to an apparatus and a method for measuring and monitoring a network slice path quality in a wireless communication system. More particularly, the disclosure relates to the apparatus and the method for measuring and monitoring the network slice path quality, using path quality information per slice, service, and terminal in the wireless communication system.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

As discussed above, with the development of the wireless communication system, a method for measuring and monitoring quality of an individual path transmitting a packet is required. In particular, what is demanded is a method for segment and end-to-end simultaneous quality measurement for path quality per slice, service, and terminal by defining path quality measurement units per slice, service, and terminal.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method for providing smooth efficiency of packet transmission in a wireless communication system.

Another aspect of the disclosure is to provide an apparatus and a method for measuring and monitoring path quality per slice, service, and terminal to discover latency and throughput decrease situations of packet transmission in a wireless communication system.

Additional aspects will be set forth in part in the description which follows and, in part, will be apparent from the description, or may be learned by practice of the presented embodiments.

In accordance with an aspect of the disclosure, a method performed by a central unit-user plane (CU-UP), in a wireless communication system is provided. The method includes receiving information related to packet transmission from a user plane function (UPF), the information related to the packet transmission including a quality of service (QoS) flow provided, a slice provided with the QoS flow, an indicator indicating a terminal for receiving the QoS flow and a time parameter related to latency quality measurement, identifying a quality measurement value based on the received information related to the packet transmission, updating the received information related to the packet transmission based on the identified quality measurement value, and transmitting the updated information related to the packet transmission to a distributed unit (DU).

In accordance with another aspect of the disclosure, a CU-UP in a wireless communication system is provided. The CU-UP includes at least one transceiver, at least one processor, and memory storing instructions that, when executed by the at least one processor, cause the CU-UP to receive information related to packet transmission from a UPF, the information related to the packet transmission including a QoS flow provided, a slice provided with the QoS flow, an indicator indicating a terminal for receiving the QoS flow and a time parameter related to latency quality measurement, identify a quality measurement value based on the received information related to the packet transmission, update the received information related to the packet transmission based on the identified quality measurement value, and transmit the updated information related to the packet transmission to a DU.

In accordance with another aspect of the disclosure, a method performed by an element management system (EMS) entity in a wireless communication system is provided. The method includes transmitting configuration information of information related to packet transmission to a central unit-user plane (CU-UP), wherein the configuration information of the packet transmission information comprises information related to at least one of a server address indication related to the CU-UP, a report policy indication, or a report type indication.

In accordance with another aspect of the disclosure, an element management system (EMS) entity in a wireless communication system is provided. The EMS entity includes at least one transceiver, at least one processor, and memory storing instructions that, when executed by the at least one processor, cause the EMS entity to transmit configuration information of information related to packet transmission to a central unit-user plane (CU-UP), wherein the configuration information of the packet transmission information comprises information related to at least one of a server address indication related to the CU-UP, a report policy indication, or a report type indication, and transmit configuration information of quality measurement release to the CU-UP, wherein the report policy indication indicates at least one of an immediate report policy or a delayed report policy, and wherein the report type indication indicates whether the CU-UP reports to a higher layer entity.

Various embodiments of the disclosure may provide an apparatus and a method for effectively providing a network service in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication network including a core network according to an embodiment of the disclosure;

FIG. 2A illustrates an example of a functional structure of a terminal according to an embodiment of the disclosure;

FIG. 2B illustrates an example of a functional structure of a base station according to an embodiment of the disclosure;

FIG. 2C illustrates an example of a functional structure of a core network entity according to an embodiment of the disclosure;

FIG. 3A illustrates an example of a path which provides a network slice service in a wireless communication system according to an embodiment of the disclosure;

FIG. 3B illustrates topologies for service level agreement (SLA) measurement of a latency and a throughput in a wireless communication system according to an embodiment of the disclosure;

FIG. 4A illustrates an example of path quality measurement and reporting per entity in a wireless communication system according to an embodiment of the disclosure;

FIG. 4B illustrates an example of real-time path quality measurement and reporting per radio access network (RAN) entity according to an embodiment of the disclosure;

FIG. 4C illustrates an example of real-time path quality measurement and reporting for each radio access network (RAN) and core network entity according to an embodiment of the disclosure;

FIG. 5A illustrates an example of a measurement unit in segment and end-to-end path quality measurement in a wireless communication system according to an embodiment of the disclosure;

FIG. 5B illustrates session, quality of service (QoS) flow, and bearer mapping for path quality measurement according to an embodiment of the disclosure;

FIG. 6 illustrates a protocol stack per entity for measuring path quality according to an embodiment of the disclosure;

FIG. 7 illustrates an example of values indicated by in-band network telemetry (INT) fields according to an embodiment of the disclosure;

FIG. 8 illustrates an example of path quality measurement and reporting per entity based on a latency according to an embodiment of the disclosure;

FIG. 9 illustrates an example of path quality measurement and reporting per entity based on a throughput according to an embodiment of the disclosure;

FIG. 10 illustrates an example of network entities including an element management system (EMS) which measures and reports quality per path according to an embodiment of the disclosure;

FIG. 11 illustrates an example of a procedure for configuring INT report by an EMS according to an embodiment of the disclosure; and

FIG. 12 illustrates an example of a protocol according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure to be described below, a hardware approach is described as an example. However, since the various embodiments of the disclosure include a technology using both hardware and software, the various embodiments of the disclosure do not exclude a software-based approach.

The disclosure provides a method for measuring and monitoring segment per slice, service and terminal of a network slice and end-to-end path quality in a wireless communication system. The path quality in the wireless communication system indicates quality on a path through which a slice is transmitted. For example, the quality on the path may indicate a latency or a throughput (Tput) occurring on a corresponding path at packet transmission to a terminal. Slice quality, which may cover all terminals served by a corresponding slice, may indicate an aggregation of each path quality in the entire wireless communication range where actual slices are generated and serviced. The path per segment may indicate an air segment (e.g., a Uu interface) between the terminal and a distributed unit (DU), and a midhaul segment (e.g., an F1-U interface) between the DU and a central unit (CU)-user plane (UP) and a backhaul segment (e.g., an N3 interface) between the CU-UP and a user plane function (UPF). The end-to-end path may indicate an entire path between the terminal and the UPF.

Various embodiments of the disclosure suggest a method for measuring segment and end-to-end path quality of a slice for an entire path. Each path quality may be measured based on at least one of per slice, per service within the slice, or per user equipment (UE) within the slice. According to an embodiment, the DU, the CU-UP, and the UPF each may report the measured path or end-to-end path quality to a network slice analytics monitoring system which is a higher layer. The network slice analytics monitoring system may configure a topology related to the quality of each path based on the quality of the reported paths. Path quality monitoring may indicate that the entities constructing the wireless communication system measure the quality in real time with respect to the path per entity configuring the slice and signal transmission per segment, and report it in real time. The network slice analytics monitoring system may generate a plurality of monitoring combinations based on the collected information. For example, the generated monitoring combinations may have the number of {slice/per service/per terminal}×{per segment/per end}×{busy hour/non-busy hour}. The network slice analytics monitoring system may generate monitoring combinations by analyzing a current state value or past history of a target path per combination of the generated monitoring combinations.

The path quality measuring and monitoring method proposed by the disclosure may be a technique related to the DU, the CU (CU-UP, CU-CP), and the UP as standalone (SA) 5G technologies which support network slices. The disclosure according to various embodiments of the disclosure may be a disclosure related to a quality measurement and reporting function of a 5G network itself not requesting to change a 5G UE or an application server. The network slice analytics function according to various embodiments of the disclosure may configure and analyze a service topology according to the latency, the throughput, and the various combinations mentioned above, by utilizing the collected path quality information reported by each DU, CU, and UPF equipment. However, according to various embodiments of the disclosure, it is not limited thereto, and it is noted that the disclosure may be applied to other wireless communication system than the 5G, and the network slice analytics function may be replaced with another function having an equivalent technique.

According to various embodiments of the disclosure, the path quality or the slice quality may indicate the latency and the Tput. However, it is not limited thereto, and an additional path quality metric such as a packet loss may be used as additional quality metric in embodiments of the disclosure. For example, it is noted that a monitoring system (e.g., the network slice analytics) may analyze various metrics such as availability, reliability, and distribution by combining the collected metrics (e.g., path quality information).

A method for measuring and monitoring the whole slice quality has been performed to measure and monitor the network slice quality in the wireless communication system. However, measuring and monitoring the quality of the whole slice may not achieve detailed measurement of quality degradation in providing a service through the slice, in that it is not to measure and monitor the individual path quality. Referring to 3rd generation partnership project (3GPP) specifications (e.g., 3GPP technical specification (TS) 28.552), if ultra-reliable low-latency communications (URLLC) slice—RAN slice subnet— {RAN air slice, RAN midhaul slice, RAN backhaul slice} subnet hierarchical structure is defined, the method for measuring and monitoring the slice quality of each layer is disclosed. The slice quality measurement may mainly utilize system statistics defined in 3GPP operation and maintenance (O&M) standard (e.g., a system statistics method of 3GPP allows each system to collect the latency or the Tput per slice on a periodic basis (e.g., every 15 minute)). Referring to another 3GPP specification, an end-to-end path quality inquiry function for a specific UE is disclosed. A QoS monitoring (QM) (e.g., 3GPP TS 23.501) procedure may be utilized to query the end-to-end path quality for the specific UE. The system statistics scheme or the per-UE inquiry scheme does not simultaneously support the path quality measurement per slice, service, or UE with respect to the whole slice path. For example, the system statistics scheme does not disclose statistics of slice path quality measurement of the backhaul segment between the CU-UP and the UPF. The UE inquiry scheme does not disclose latency quality measurement per segment for each service path of all UEs in the slice. The per-UE inquiry scheme of the 3GPP standard is defined merely as the inquiry function for a specific UE, and does not disclose the quality measurement method for the whole path per service of each UE. The quality measurement scheme disclosed in the 3GPP specifications may not be fit for the purpose of the path quality per slice, service, or UE.

According to various embodiments of the disclosure, a method for measuring segment and end-to-end path qualities of a whole path with respect to a slice is disclosed. According to an embodiment, a unit for measuring the path quality per slice, service, or UE is disclosed. According to an embodiment, a scheme for simultaneously measuring the path quality per slice, service, or UE and the end-to-end path quality is disclosed. According to an embodiment, a real-time direct measurement scheme based on time of the path actually transmitting a packet is disclosed. According to an embodiment, the scheme for measuring the latency and the Tput as the path quality is disclosed, and a measurement and monitoring structure which may be extended to other quality metric than the latency and the Tput is disclosed. An apparatus and a method according to various embodiments of the disclosure disclose segment and end-to-end quality measurement of a whole path with respect to a slice path. According to the embodiments of the disclosure, a measurement unit per slice, service, or UE is disclosed, and transmission quality may be measured and reported in real time according to the path of the actual packet transmission based on the measurement unit. According to the embodiments of the disclosure, the quality measurement and monitoring method for the latency and the Tput is disclosed, but is not limited thereto, and may have the same effect of the disclosure with respect to other path quality measurement such as packet loss rate. According to various embodiments of the disclosure, measuring and monitoring the quality of the individual path may provide smooth efficiency in providing a network service.

The disclosure provides an apparatus and a method for measuring and monitoring path quality per slice, service, and UE to discover a situation where packet latency and Tput degrade in a wireless communication system. The disclosure suggests interfaces, core networks, and workflows but an entity operation defined as a function is not construed as limiting specific implementation.

As 5G new radio (NR) is introduced in the wireless communication system, a radio access network (RAN) and a core network (CN) have a separated structure in terms of standard and product. The RAN and the CN are separately managed in terms of a communication operator. However, in terms of the technical aspect, since packets in a user plane (UP) are processed based on a user session, it may be advantageous for high communication performance to arrange an entity which manages the UP of the RAN and the UPF of the CN work together. Hence, the disclosure proposes a structure which integrates at least a part of the UPF and the UP of the RAN. Hereafter, the structure which combines at least a part of the UPF and the CU-CP of the RAN shall be described, but embodiments of the disclosure are not limited thereto. The UPF is not limited to the structure which integrates the UP with the RAN, and may be deployed inside the DU or in an intermediate network function such as a cell site router (CSR).

The network structure (hereafter, a UP integration based CN) according to the UP integration of the RAN and the CN (e.g., the UPF) may simplify the wireless communication system to eliminate unnecessary IP packet manipulation and to reduce packet latency. User traffic may be transmitted over the UP integration based CN instead of a cloud, by virtue of the UP integration of the RAN and the CN (e.g., the UPF). Since the user traffic is transmitted over the UP integration based CN, a communication operator may switch the network into a cloud based network at a low cost. The disclosure describes a technique for signal transmission of each node in the UP integration based CN, in the wireless communication system.

Hereafter, terms for identifying access nodes, terms indicating network entities, terms indicating messages, terms indicating interfaces between network entities, terms indicating various identification information, and the like are illustratively used in the description for the sake of convenience. Accordingly, the disclosure is not limited by the terms to be described, and other terms indicating subjects having equivalent technical meanings may be used.

In addition, the disclosure describes various embodiments using terms used in some communication standard (e.g., 3GPP), but this is only an example for description. Various embodiments of the disclosure may be easily modified and applied in other communication system. Hereafter, some terms used in the CN of the disclosure are predefined.
AMF Access and Mobility Management Function
CN Core Network
CNF Containerized Network Function
DNN Data Network Name
PCF Policy Control Function
HSS Home Subscriber Server
SMF Session Management Function
UDM User Data Management
UPF User Plane Function
CNF Containerized Network Function
VNF Virtual Network Function

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

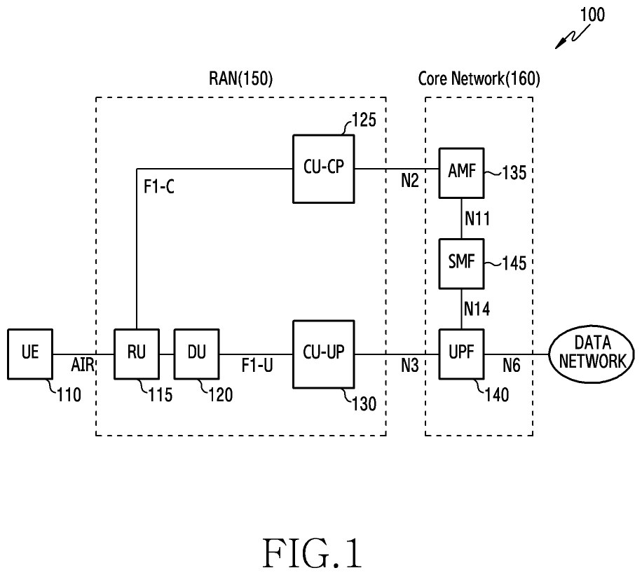

FIG. 1 illustrates a communication network 100 including a CN according to an embodiment of the disclosure. The communication network 100, which is a communication system for establishing a 5G network, may include a UPF 140, an AMF 135 an SMF 145, a PCF (not shown), a UDM (not shown), and an HSS (not shown).

A UE 110 may perform communication over a radio channel established with a base station (e.g., an evolved Node B (eNB), a next generation nodeB (gNB)), that is, over an access network. In some embodiments, the UE 110 is a device used by a user, and may be configured to provide a user interface (UI). For example, the UE may be a terminal equipped in a vehicle for driving. In some other embodiments, the UE 110 may be a device performing machine type communication (MTC) operated without user's involvement, or an autonomous vehicle. Besides an electronic device, the UE may be referred to as a ‘terminal’, a ‘vehicle terminal’, a ‘UE’, a ‘mobile station’, a ‘subscriber station’, a ‘remote terminal’, a ‘wireless terminal’, a ‘user device’ or other term having the equivalent technical meaning. As the terminal, a customer-premises equipment (CPE) or a dongle type terminal may be used besides the UE. The CPE may be connected to an NG-RAN node like a UE, to provide the network to other communication equipment (e.g., a laptop).

Referring to FIG. 1, the UE 110 may be connected to the UPF 140 of the 5G CN via a RAN node 150. The RAN node 150, which is the radio access network, may provide a radio channel for accessing the 5G CN. The RAN node 150 may indicate a base station. The RAN node 150 is a network infrastructure which provides the wireless access to the UE 110. The base station has coverage defined as a specific geographic area based on a signal transmission distance. The base station may be referred to as, besides the base station, an ‘access point (AP)’, an ‘eNB’, a ‘wireless point’, a ‘5G node’, a ‘5G nodeB (5GNB)’, a ‘gNB’, a ‘wireless point’, a ‘transmission/reception point (TRP)’, an ‘access unit’, a ‘DU’, a ‘radio unit (RU), a ‘remote radio head (RRH)’ or other term having technically equivalent meaning. The configuration of the base station does not limit the base station example for carrying out various embodiments of the disclosure. That is, according to various embodiments, some configuration may be added, deleted, or changed.

The base station according to various embodiments of the disclosure may be implemented to build an access network having distributed deployment as well as integrated deployment (e.g., an eNB of long term evolution (LTE)). As illustrated, the base station is divided into CUs 125 and 130 and a DU 120, and the CUs 125 and 130 may be implemented to perform upper layers (e.g., packet data convergence protocol (PDCP), radio resource control (RRC)) and the DU 120 may be implemented to perform lower layers (e.g., media access control (MAC), physical (PHY)).

As such, the base station having the distributed deployment may further include a configuration for fronthaul interface communication. According to an embodiment, the base station, as the DU 120, may perform functions for transmitting and receiving a signal in a wired communication environment. The DU 120 may include a wired interface, for controlling a direct connection between a device and a device through a transmission medium (e.g., copper wire, optical fiber). For example, the DU 120 may transmit an electrical signal to another device through a copper wire, or perform conversion between an electrical signal and an optical signal. The DU 120 may be connected to the CUs 125 and 130 of the distributed deployment. However, this description is not construed to exclude a scenario in which the DU 120 is connected to the CUs 125 and 130 over a wireless network. In addition, the DU may be additionally connected to an RU 115. However, this description is not construed as excluding a wireless environment including only the CUs 125 and 130 and the DU 120.

Referring to FIG. 1, the AMF 135 provides functions for access and mobility management based on the UE 110, and one UE 110 may be basically connected to one AMF 135. Specifically, the AMF 135 may perform at least one function of signaling between core network nodes for mobility between 3GPP access networks, interface (N2 interface) between radio access networks (e.g., a 5G RAN), non-access stratum (NAS) signaling with a UE, identifying the SMF 145, and delivering a session management (SM) message between the UE 110 and the SMF 145. Some or all of the functions of the AMF 135 may be supported within a single instance of one AMF 135.

The SMF 145 provides a session management function, and if the UE 110 has a plurality of sessions, the sessions may be managed by different SMFs 145 respectively. Specifically, the SMF 145 may perform at least one function of session management (e.g., session establishment, modification and release including tunnel maintenance between the UPF 140 and an access network node), UP function selection and control, traffic steering configuration for routing traffic from the UPF 140 to a proper destination, termination of the SM part of the NAS message, downlink data notification, and delivery of AN specific SM information to the access network through the N2 interface via an initiator (the AMF 135). Some or all functions of the SMF 145 may be supported within a single instance of one SMF 145.

Although not depicted in FIG. 1, an interface between the UPF 140 and other UPF may be referred to as an N9 interface.

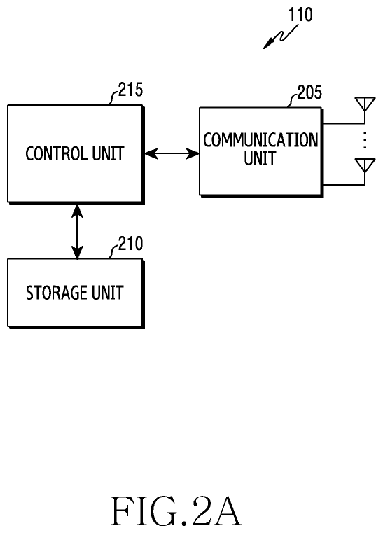

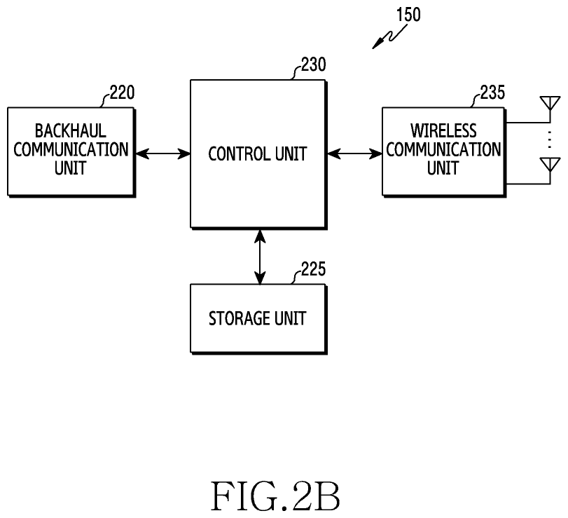

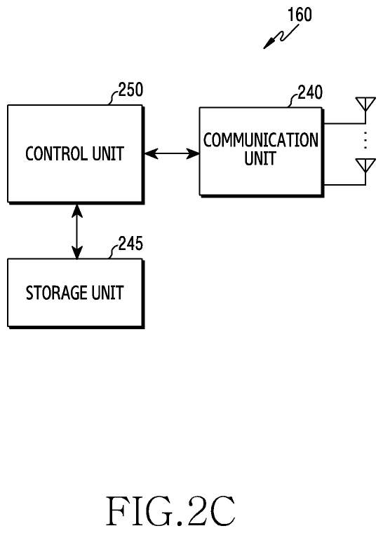

FIG. 2A illustrates an example of a functional structure of a terminal according to an embodiment of the disclosure. The configuration illustrated in FIG. 2A may be understood as the configuration of the UE 110. Hereafter, a term such as ‘˜unit’ or ‘˜er’ used hereafter indicates a unit for processing at least one function or operation, and may be implemented using hardware, software, or a combination of hardware and software.

Referring to FIG. 2A, the terminal includes a communication unit 205, a storage unit 210, and a control unit 215.

The communication unit 205 performs functions for transmitting or receiving a signal over a radio channel. For example, the communication unit 205 performs a conversion function between a baseband signal and a bit stream according to a physical layer standard of the system. For example, in data transmission, the communication unit 205 generates complex symbols by encoding and modulating a transmit bit stream. Also, in data reception, the communication unit 205 restores a receive bit stream by demodulating and decoding a baseband signal. Also, the communication unit 205 up-converts a baseband signal into a radio frequency (RF) band signal and transmits the same via an antenna, and down-converts an RF band signal received through an antenna into a baseband signal. For example, the communication unit 205 may include a transmit filter, a receive filter, an amplifier, a mixer, an oscillator, a digital to analog converter (DAC), an analog to digital converter (ADC), and so on.

Also, the communication unit 205 may include a plurality of transmit and receive paths. Further, the communication unit 205 may include at least one antenna array including a plurality of antenna elements. In terms of hardware, the communication unit 205 may include a digital circuit and an analog circuit (e.g., a radio frequency integrated circuit (RFIC)). Herein, the digital circuit and the analog circuit may be implemented in a single package. In addition, the communication unit 205 may include a plurality of RF chains. Further, the communication unit 205 may perform beamforming.

The communication unit 205 transmits and receives the signal as described above. Accordingly, whole or a part of the communication unit 205 may be referred to as a ‘transmitter’, a ‘receiver’, or a ‘transceiver’. Also, the transmission and reception conducted over the radio channel is used to embrace the above-described processing performed by the communication unit 205 in the following description.

The storage unit 210 stores data such as a basic program, an application program, and setting information for the operation of the terminal. The storage unit 210 may be configured with a volatile memory, a non-volatile memory, or a combination of a volatile memory and a non-volatile memory. The storage unit 210 provides the stored data at a request of the control unit 215.

The control unit 215 controls general operations of the terminal. For example, the control unit 215 transmits and receives a signal through the communication unit 205. In addition, the control unit 215 records and reads data in and from the storage unit 210. The control unit 215 may perform functions of a protocol stack required by the communication standard. For doing so, the control unit 215 may include at least one processor or a micro-processor, or may be a part of a processor. Also, a part of the communication unit 205 and the control unit 215 may be referred to as a communication processor (CP). According to various embodiments, the control unit 215 may control to perform synchronization using the wireless communication network. For example, the control unit 215 may control the terminal to carry out operations to be described according to various embodiments.

FIG. 2B illustrates an example of a functional structure of a base station according to an embodiment of the disclosure. The configuration illustrated in FIG. 2B may be understood as the configuration of the base station 150. Hereafter, a term such as ‘˜unit’ or ‘˜er’ used hereafter indicates a unit for processing at least one function or operation, and may be implemented using hardware, software, or a combination of hardware and software.

Referring to FIG. 2B, the base station includes a wireless communication unit 235, a backhaul communication unit 220, a storage unit 225, and a control unit 230.

The wireless communication unit 235 performs functions for transmitting or receiving a signal over the radio channel. For example, the wireless communication unit 235 performs a conversion function between a baseband signal and a bit stream according to the physical layer standard of the system. For example, in data transmission, the communication unit 235 generates complex symbols by encoding and modulating a transmit bit stream. Also, in data reception, the wireless communication unit 235 restores a receive bit stream by demodulating and decoding a baseband signal.

Also, the wireless communication unit 235 up-converts a baseband signal into an RF band signal and transmits the same via an antenna, and down-converts an RF band signal received through an antenna into a baseband signal. For doing so, the wireless communication unit 235 may include a transmit filter, a receive filter, an amplifier, a mixer, an oscillator, a DAC, an ADC, and the like. Also, the wireless communication unit 235 may include a plurality of transmit and receive paths. Further, the wireless communication unit 235 may include at least one antenna array including a plurality of antenna elements.

In terms of hardware, the wireless communication unit 235 may include a digital circuit and an analog circuit, and the analog unit may include a plurality of sub-units according to an operating power, an operating frequency, and so on. The digital unit may be implemented with at least one processor (e.g., a digital signal processor (DSP)).

The wireless communication unit 235 transmits and receives the signal as described above. Accordingly, whole or a part of the wireless communication unit 235 may be referred to as a ‘transmitter’, a ‘receiver’, or a ‘transceiver’. In addition, in the following description, the transmission and reception conducted over the radio channel may be used to embrace the above-described processing performed by the wireless communication unit 235.

The backhaul communication unit 220 provides an interface for communicating with other nodes in the network. That is, the backhaul communication unit 220 converts a bit stream transmitted from the base station to other node, for example, other access node, another base station, an upper node, a core network, and so on, into a physical signal, and converts a physical signal received from other node into a bit stream.

The storage unit 225 stores data such as a basic program, an application program, and setting information for the operations of the base station. The storage unit 225 may be configured with a volatile memory, a non-volatile memory or a combination of a volatile memory and a non-volatile memory. The storage unit 225 may provide the stored data at a request of the control unit 230.

The control unit 230 controls general operations of the base station. For example, the control unit 230 transmits and receives a signal through the wireless communication unit 235 or the backhaul communication unit 220. In addition, the control unit 230 records and reads data in and from the storage unit 225. The control unit 230 may perform functions of the protocol stack required by the communication standard. According to another implementation, the protocol stack may be included in the wireless communication unit 235. For doing so, the control unit 230 may include at least one processor. According to various embodiments, the control unit 230 may control to perform the synchronization using the wireless communication network. For example, the control unit 230 may control the base station to perform operations to be described according to the various embodiments.

FIG. 2C illustrates an example of a functional structure of a core network entity according to an embodiment of the disclosure. A configuration 160 shown in FIG. 2C may be understood as the configuration of the device having at least one of the functions 135, 140, and 145 of FIG. 1. Hereafter, a term such as ‘˜unit’ or ‘˜er’ used hereafter indicates a unit for processing at least one function or operation, and may be implemented using hardware, software, or a combination of hardware and software.

Referring to FIG. 2C, the core network entity includes a communication unit 240, a storage unit 245, and a control unit 250.

The communication unit 240 provides an interface for communicating with other nodes in the network. That is, the communication unit 240 converts a bit stream transmitted from the core network entity to other device into a physical signal, and converts a physical signal received from other device into a bit stream. That is, the communication unit 240 may transmit and receive signals. Hence, the communication unit 240 may be referred to as a modem, a transmitter, a receiver or a transceiver. In this case, the communication unit 240 enables the core network entity to communicate with other devices or systems via a backhaul connection (e.g., wired backhaul or wireless backhaul) or the network.

The storage unit 245 stores data such as a basic program, an application program, and setting information for the operations of the core network entity. The storage unit 245 may be configured with a volatile memory, a non-volatile memory, or a combination of a volatile memory and a non-volatile memory. The storage unit 245 may provide the stored data at a request of the control unit 250.

The control unit 250 controls general operations of the core network entity. For example, the control unit 250 transmits and receives a signal through the communication unit 240. In addition, the control unit 250 records and reads data in and from the storage unit 245. For doing so, the control unit 250 may include at least one processor. According to various embodiments of the disclosure, the control unit 250 may control to perform the synchronization using the wireless communication network. For example, the control unit 250 may control the core network entity to carry out operations to be described according to various embodiments.

Hereafter, terms for identifying access nodes, terms indicating network entities, terms indicating messages, terms indicating interfaces between network entities, terms indicating various identification information, and the like are illustratively used in the description for the sake of convenience. Accordingly, the disclosure is not limited by the terms to be described, and other terms indicating subjects having equivalent technical meanings may be used.

To facilitate the description, the disclosure uses terms and names defined in 5G system (5GS) and NR standards which are the latest standards defined by the 3GPP organization among the currently existing communication standards. However, the disclosure is not limited by the terms and the names, and may be equally applied to a wireless communication network which complies with other standard. Particularly, the disclosure may be applied to the 3GPP 5G mobile communication standard (e.g., 5GS and NR).

### 1. Path Quality Measurement and Monitoring Structure

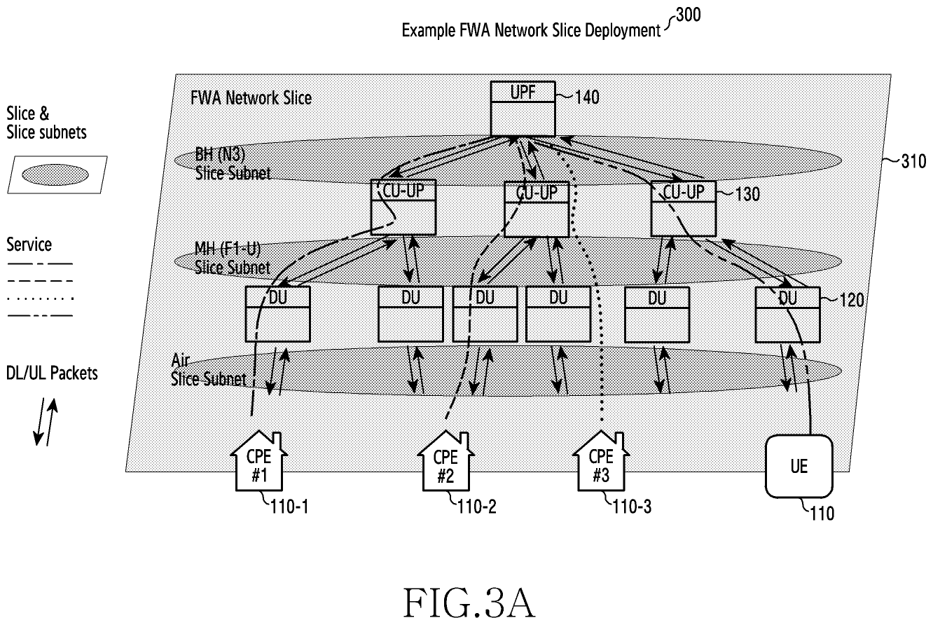

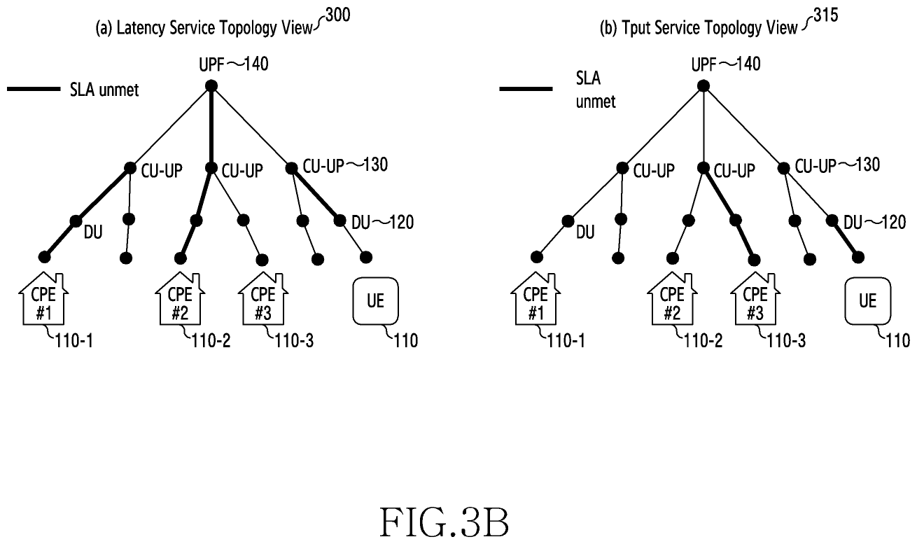

FIG. 3A illustrates an example of a path for providing a network slice service in a wireless communication system according to an embodiment of the disclosure. Specifically, FIG. 3A illustrates the example of network slice deployment in a public macro 5G system.

Referring to FIG. 3A, in the 5G network system, a fixed wireless access (FWA) service may be provided from a UPF to a plurality of UEs 110, 110-1, 110-2, and 110-3 through network slices. The UE receiving the service may be, but not limited thereto, a movable UE 110 of an FWA subscriber, and may be a CPE 110-1, 110-2, and 110-3 geographically fixed. Each UE 110 may receive the service from the UPF 140 through a different path. The service provided to each UE 110 may be initiated from one UPF 140 and provided to each UE by way of one CU-UP 130 among a plurality of CU-UPs 130 and one DU 120 among a plurality of DUs 120. The service provided from one UPF 140 may be provided through a path located in the same slice 310. In one slice 310, slice subnets may be located for interfaces (e.g., N3, F1-U, Uu (Air)) between the CN entities. Referring to FIG. 3A, it is noted that a plurality of service provision paths is included in, but not limited to, one slice, but the service provided to the UE 110 may be provided through a plurality of slices. FIG. 3A illustrates one service provided to each UE 110, but each UE 110 may receive a plurality of services through a plurality of paths (e.g., paths including different CU-UPs and DUs).

Referring to FIG. 3A, each UE 110 may use various paths even if using the same slice to receive the service. A quality of the service provided through various paths may differ for each path. The service transmitted to each UE 110 may be efficiently measured in quality only by adaptively adjusting quality measurement along each path, and the UE 110 may receive the service with the improved quality per path.

FIG. 3B illustrates an example of topologies for service level agreement (SLA) measurement of the latency and the Tput in the wireless communication system according to an embodiment of the disclosure.

Specifically, referring to FIG. 3B, a service topology view per quality metric to be monitored by the operator is illustrated according to embodiments of the disclosure. The topology view of FIG. 3B is illustrated by simplifying the service paths per UE shown in FIG. 3A. The wireless communication operator may monitor each segment and end-to-end quality for the entire FWA network path through the quality service topology view. The operator may pre- or post-monitor a UE not satisfying the SLA through the topology view.

Referring to FIG. 3B, a topology (a) 300 illustrates the latency service topology view showing the latency quality in a serving FWA network slice. A plurality of paths for receiving the service per UE and path segments not satisfying the SLA based on the latency quality are depicted. For example, referring to part (a) of FIG. 3B, the service received by the CPE #1 110-1 may not satisfy the SLA in relation to the latency in segments between a first CU-UP and a first DU, and the first DU and the UE 110-1. The service received by the CPE #2 110-2 may not satisfy the SLA in relation to the latency in segments between the UPF 140, a second CU-UP, a third DU, and the UE 110-2. The service received by the UE 110 may not satisfy the SLA in relation to the latency in a segment between a third CU-UP and a sixth DU.

A service topology (b) 315 illustrates the Tput service topology view showing the Tput quality in the same slice. A plurality of paths for receiving the service per UE and path segments not satisfying the SLA based on the latency quality are depicted. For example, referring to part (b) of FIG. 3B, the service received by the CPE #3 110-3 may not satisfy the SLA in relation to the Tput in segments between the second CU-UP, a fourth DU and the UE 110-3. The service received by the UE 110 may not satisfy the SLA in relation to the latency in a segment between the sixth DU and the UE 110.

The operator may monitor in real time whether the latency or the Tput of a specific UE meets the SLA in a specific path through the service topology view related to the latency or the Tput. In addition, if the service transmission quality of a specific UE or a specific path does not meet the SLA, the unmet specific UE or specific path may be determined.

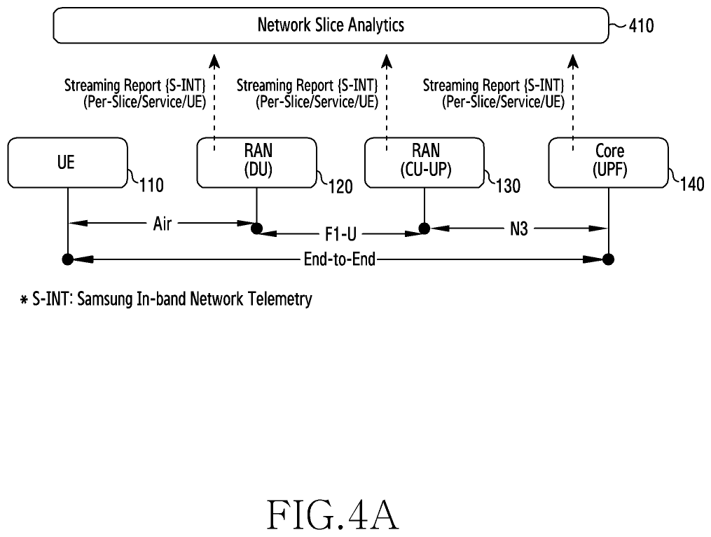

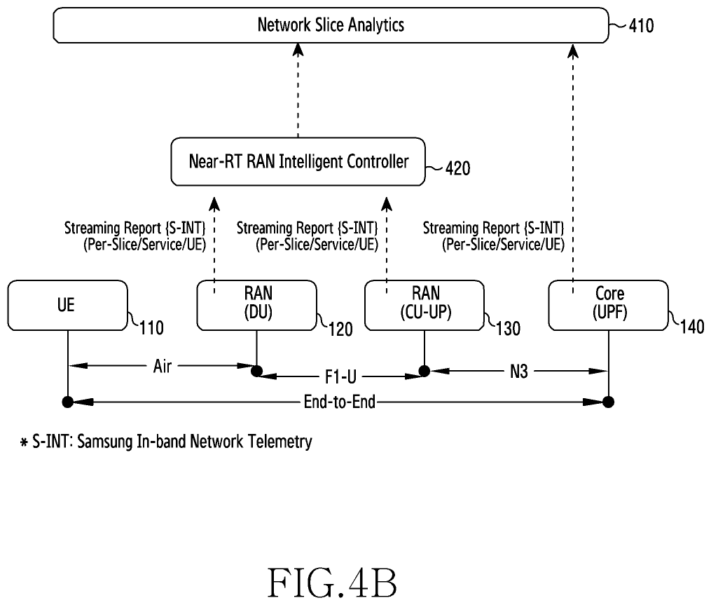

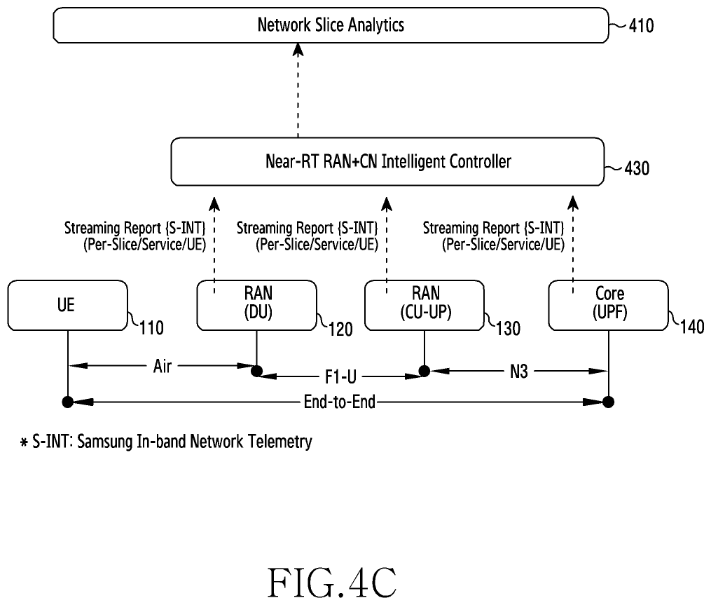

FIG. 4A illustrates an example of path quality measurement and reporting per entity in a wireless communication system according to an embodiment of the disclosure.

Referring to FIG. 4A, a data packet transmission path segment may be divided into an air segment (a Uu interface), a midhaul segment (an F1-U interface), a backhaul segment (an N3 interface), and an end-to-end segment between the UE 110 and the UPF 140. The air segment (the Uu interface) may refer to a segment between the UE 110 and the DU 120. The midhaul segment (the F1-U interface) may refer to a segment between the DU 120 and the CU-UP 130. The backhaul segment (the N3 interface) may refer to a segment between the CU-UP 130 and the UPF 140.

If transmitting a packet in a downlink (DL) or uplink (UL) direction, nodes of the DU 120, the CU-UP 130, and the UPF 140 may update information transmitted from a previous node transmitting the packet and path quality information measured at a corresponding node. The nodes each may report (e.g., streaming report) the updated quality result to a network slice analytics in real time. The nodes each may use a protocol including an in-band network telemetry (INT) indicator to report the quality result to the network slice analytics. The INT indicator may indicate whether the included protocol is quality measurement per slice, service, or UE. According to various embodiments of the disclosure, referring to FIGS. 4A to 4C, although S-INT is depicted, this may also be referred to as the INT, and the INT may have an equivalent meaning to the S-INT.

FIG. 4B illustrates an example of real-time path quality measurement and reporting per RAN entity according to an embodiment of the disclosure.

Specifically, referring to FIG. 4B, a quality measurement and reporting structure modified from the quality measurement and reporting structure of the entities (e.g., the DU 120, the CU-UP 130) functioning as the RAN 150 shown in FIG. 4A by utilizing a RAN controller (a near-real time (RT) RAN intelligent controller (RIC)) of open (O)-RAN standard is depicted.

Referring to FIG. 4B, the DU 120 and the CU-UP 130 which are the entities performing the RAN function may report the updated quality result to a near-RT RIC 420. The near-RT RIC 420 is an entity which manages the individual function of the RAN, and may manage an event and a resource requiring a fast response (e.g., 10 ms) in near real time. Referring to FIG. 4B, the nodes 120 and 130 performing the RAN function may measure and report the path quality in real time, by reporting the quality measurement information to the near-RT RIC 420. As the RAN nodes 120 and 130 report the quality measurement information to the near-RT RIC 420, the near-RT RIC 420 may satisfy the SLA of the RAN slice in real time, by comparing and monitoring the individual path quality of the RAN nodes 120 and 130 acquired in real time and the RAN slice SLA to guarantee. The near-RT RIC 420 may report the collected quality information to the network slice analytics, and concurrently monitor the path quality of each of the nodes.

FIG. 4C illustrates an example of real-time path quality measurement and reporting per RAN and CN entity according to an embodiment of the disclosure.

Specifically, referring to FIG. 4C, a quality measurement and reporting structure modified from the quality measurement and reporting structure of the entities (e.g., the DU 120, the CU-UP 130) performing the function of the RAN 150 and the UPF 140 which is the CN function entity shown in FIG. 4A and FIG. 4B by utilizing and expanding the RAN controller of O-RAN standard is depicted.

Referring to FIG. 4C, the near RT controller may manage nodes including not only the RAN 150 but also the CN (e.g., the UPF 140) in conjunction. The near RT controller shown in FIG. 4C may be referred to as a near RT RAN+CN intelligent controller 430. The DU 120 and the CU-UP 130 which are the RAN function entities and the UPF 140 which is the CN entity may report the updated quality result to the near RT RAN+CN intelligent controller 430. The near-RT RAN+CN intelligent controller 430 is an entity which manages the individual function of the RAN and the CN and may manage an event and a resource requiring a fast response (e.g., 10 ms) in near real time. Referring to FIG. 4C, the RAN function nodes 120 and 130 and the UPF 140 may measure and report the path quality in real time, by reporting quality measurement information to the near-RT RAN+CN intelligent controller 430. As the RAN nodes 120 and 130 and the UPF 140 report the quality measurement information to the near-RT RAN+CN intelligent controller 430, the near-RT RAN+CN intelligent controller 430 may satisfy the SLA of the RAN slice in real time, by comparing and monitoring the individual path quality of the RAN nodes 120 and 130 and the UPF 140 acquired in real time and the RAN slice SLA to guarantee. The near-RT RAN+CN intelligent controller 430 may report the collected quality information to the network slice analytics, and concurrently monitor the path quality of each of the nodes.

### 2. Path Quality Measurement Unit and Mapping Per Slice/Service/UE

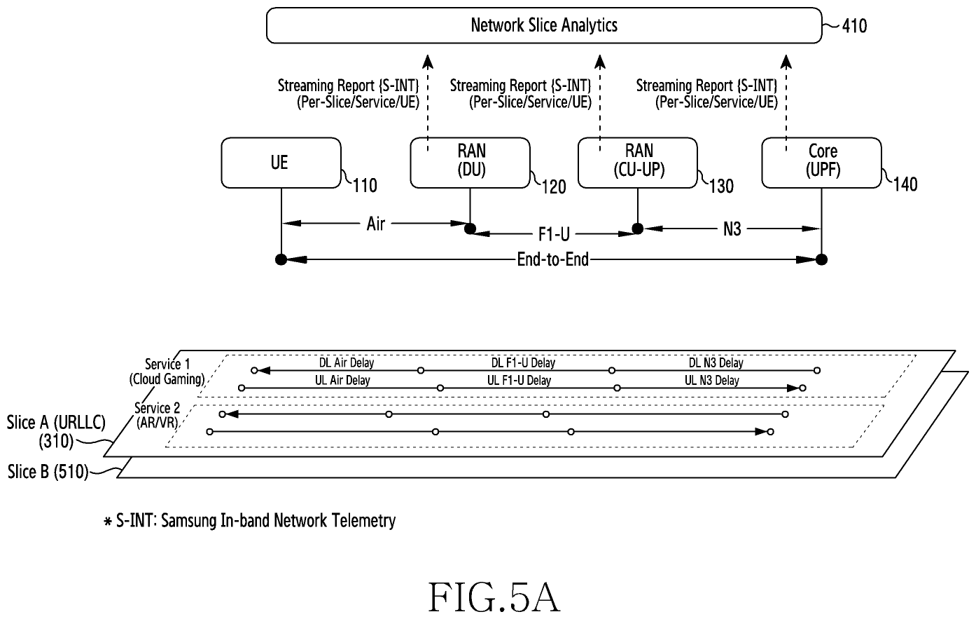

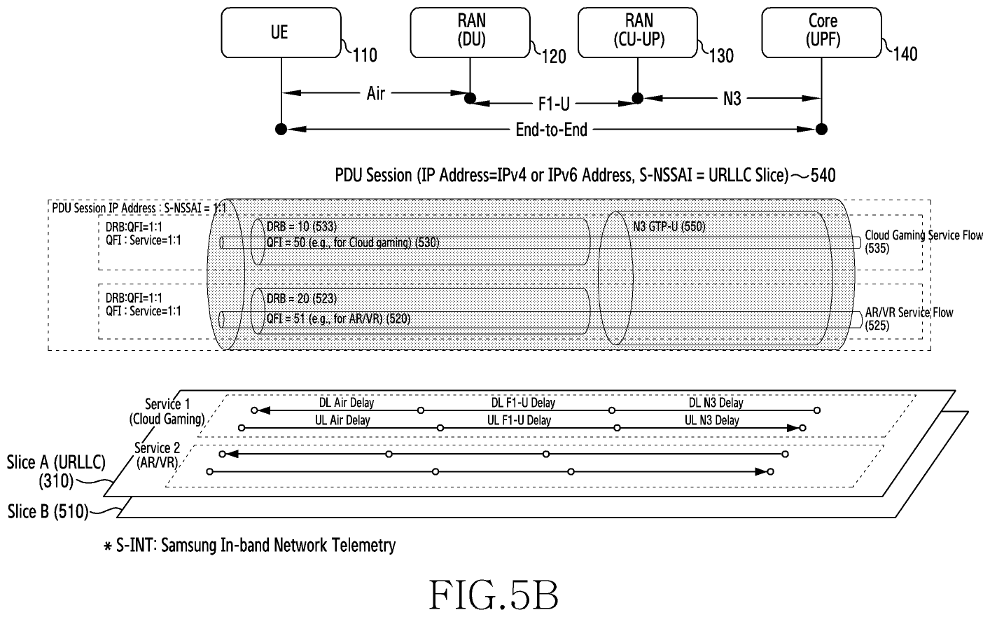

FIG. 5A illustrates an example of a measurement unit in segment and end-to-end path quality measurement according to an embodiment of the disclosure.

Specifically, according to various embodiments of the disclosure, the path quality measurement unit may be defined per slice, service, or UE. The path quality measurement unit defined with reference to FIG. 5A may be applied to all the examples shown in FIGS. 1, 2A to 2C, 3A, 3B, 4A to 4C, 5A, 5B, and 6 to 12. The unit measurement per slice may refer to slice based quality measurement using a corresponding path, if measuring the quality of a specific path. The unit measurement per service may refer to service based measurement using a corresponding path. The unit measurement per UE may refer to UE based measurement using a corresponding path. According to various embodiments of the disclosure, identification per measurement unit may be allowed, using a packet on a corresponding path used by each service provided to each UE. According to various embodiments of the disclosure, referring to FIG. 5A and FIG. 5B, although S-INT is depicted, this may also be referred to as the INT, and the INT may have an equivalent meaning to the S-INT.

Referring to FIG. 5A, a plurality of network slices for providing a network service may exist depending on the service. A slice A 310 may be a slice for the URLLC. A slice B 510 is a different slice from the slice A and may provide a separate service or the service to a separate UE. The measurement unit per slice may be identified and distinguished with single network slice selection assistance information (S-NSSAI) defined by 3GPP.

According to an embodiment, a plurality of services may be provided to a UE through the slice A 310. The plurality of the services may include, but not limited to, a different service 1 (e.g., a cloud gaming service) 530 or a service 2 (augmented reality (AR)/virtual reality (VR)) 520 and may include two or more services. The service 1 and the service 2 may be provided to the UE through different paths (e.g., the DU 120, the CU-UP 130, the UPF 140). Since the services are provided through the different paths respectively, they may have different quality characteristics. The measurement unit per service may be identified and distinguished with a quality of service flow identifier (QFI) defined by 3GPP.

According to an embodiment, different or identical services may be provided to a plurality of UEs. The measurement unit per UE may be distinguished with as an IPv4 or IPv6 address of a protocol data unit (PDU) session allocated to the UE, for a corresponding slice.

Referring to FIG. 5A, the service 1 may be provided from the UPF to the UE (e.g., in DL transmission), and the service 1 provided to the UE may be provided via N3, F1-U, and air segments. If the service 1 is transmitted via each segment, a delay may occur for each segment. According to various embodiments of the disclosure, the nodes each measure and report the transmission quality per path, and thus the quality occurring in transmitting the service 1 may be measured and monitored per path.

FIG. 5B illustrates session, quality of service (QoS) flow & bearer mapping for path quality measurement according to an embodiment of the disclosure.

Referring to FIG. 5B, according to various embodiments of the disclosure, the slices 310 and 510 of the UE 110 for receiving the service and a PDU session 540 allocated to the UE 310 may correspond one-to-one. The PDU session 540 may identify the UE 110 for receiving the service using an IP address (IPv4 address or IPv6 address) and an S-NSSAI identifier indicating a corresponding slice (e.g., the URLLC slice 310). To identify services included in the slices 310 and 510, the services within the PDU session 540 and QFIs 525 and 535 may correspond one-to-one. The RAN 150 assumes one-to-one correspondence of the services (e.g., specific QoS flows identified with the QFI) and RAN data radio bearers (DRBs) 523 and 533. For example, referring to FIG. 5B, the QFI 535 may be allocated as 50 for the cloud gaming service 530. For the AR/VR service 520, the QFI 525 may be allocated as 51. Each service QoS flow in the RAN 150 may be mapped to one RAN bearer (DRB) 523 or 533.

According to an embodiment, a slice may be identified with the S-NSSAI identifier, a service may be identified with the QFI identifier, and a UE may be identified with the PDU session IP address identifier. All of the identifiers mentioned above may be obtained on path transmitting the packet. No separate system is required. The disclosure assumes the following mapping.

According to an embodiment, one UE may have up to 8 slices (e.g., up to 8 S-NSSAI identifiers). However, this is only an example and is not limited thereto, and one UE may have 8 or more slices. One S-NSSAI identifier and one PDU session IP address may have one-to-one correspondence. A plurality of PDU session services may exist. One service may have a one-to-one correspondence relationship with the QFI. The RAN bearer (DRB) and the QFI may have one-to-one correspondence. An N3 GTP-U tunnel 550 between the RAN 150 and the UPF 140 may include a plurality of services. An N3 general packet radio service tunneling protocol-user plane (GTP-U) tunnel 550 may include at least one of the QFI 535 for the cloud gaming service flow or the QFI 525 for the AR/VR service flow.

### 3. Path Quality Measurement and Monitoring Protocol

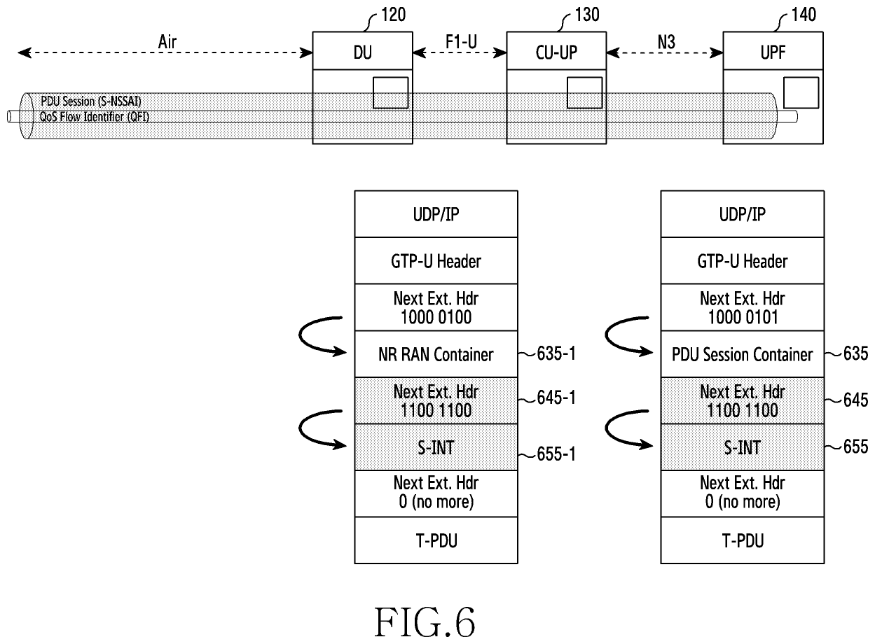

FIG. 6 illustrates a protocol stack per entity for measuring path quality according to an embodiment of the disclosure.

According to various embodiments of the disclosure, a format and a protocol including INT may be defined. According to an embodiment, a GTP-U encapsulation header defined in the standard may be extended and utilized for the quality measurement per path between the DU 120 and the CU-UP 130, and the CU-UP 130 and the UPF 140 in the 5G system. By utilizing the GTP-U encapsulation header, the quality may be measured on the packet path transmitted and received in the actual 5G network. Quality measurement information may be defined using the INT defined according to embodiments of the disclosure. According to an embodiment, the quality measurement per segment path may be achieved, by exchanging information including the INT information in real time in packet transmission between the DU 120 and the CU-UP 130, and the CU-UP 130 and the UPF 140. According to various embodiments of the disclosure, referring to FIG. 6, although the S-INT is illustrated, this may also be referred to as the INT, and the INT may have an equivalent meaning to the S-INT.

Referring to FIG. 6, according to an embodiment, the path quality information transmitted as the GTP-U extension header may be defined as an INT header. An identifier for the INT next header may be defined as 1100 1100. Referring to FIG. 6, although it is illustrated that the identifier of the INT next ext. header is set to 1100 1100, which is only an example, its identification value is a value assigned per operator and is not limited to the above-described value. As aforementioned in FIGS. 1, 2A to 2C, 3A, 3B, 4A to 4C, 5A, and 5B, in the segment between the DU 120 and the CU-UP 130, an identifier of a next ext. header 645-1 may be set to 1100 1100 together with an NR RAN container 635-1 defined in 3GPP. Information of an INT header 655-1 may be included and transmitted together with the identifier of the next ext. header 645-1 which is set to 1100 1100. In the segment between the CU-UP 130 and the UPF 140, an identifier of a next ext. header 645 may be set to 1100 1100 together with a PDU session container 635 defined in 3GPP. Information of an INT header 655 may be transmitted together with the identifier of the next ext. header 645 which is set to 1100 1100. According to various embodiments of the disclosure, the same INT header information may be used for both F1-U and N3 segments and both the DL and the UL, but it is not limited thereto and INT header including other information may be used.

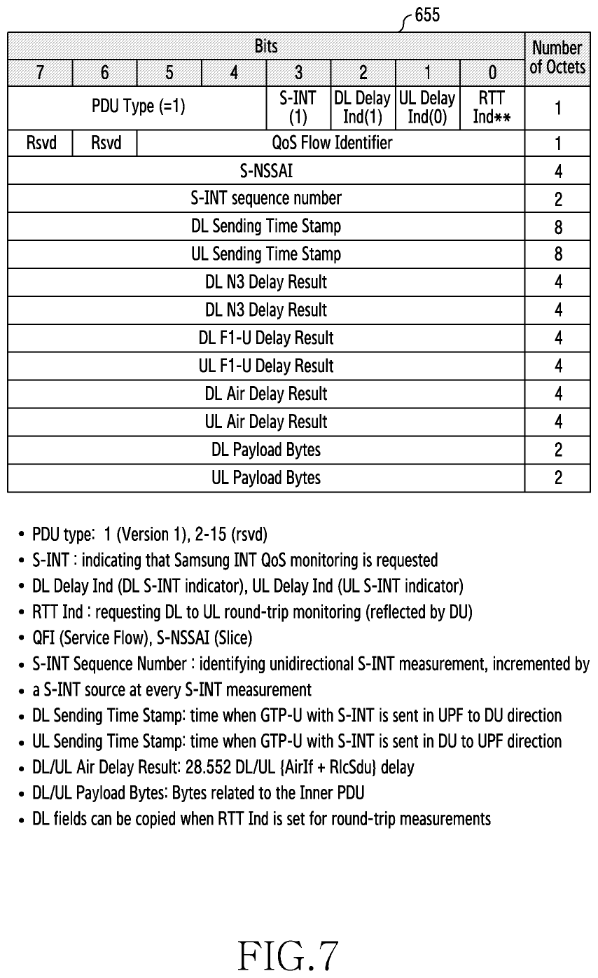

FIG. 7 illustrates an example of values indicated by INT fields according to an embodiment of the disclosure.

Specifically, referring to FIG. 7, field values related to measurement information included in an INT header are illustrated. According to various embodiments of the disclosure, referring to FIG. 7, although the S-INT is illustrated, this may also be referred to as the INT, and the INT may have an equivalent meaning to the S-INT.

Referring to FIG. 7, INT header information may include at least one of type information for identifying a PDU, an INT indicator flag indicating INT enabling, a DL delay ind for indicating DL, UL, and RTT (bidirectional) delay types indicating the INT measurement direction, a UL delay ind or a round trip time (RTT) ind field. According to an embodiment, the INT indicator flag may indicate whether INT QoS monitoring is required.

According to an embodiment, the INT information may further include at least one of S-NSSAI which is a slice identifier, a QoS flow identifier which is a service identifier within a slice or an INT sequence number field. A PDU session IP address which is a UE identifier may be included in a packet encapsulated with GTP-U. The INT sequence number field indicates a different service flow of the same service. Hence, at least one of the slice of the transmitted packet, the service or the UE may be identified based on the INT information. According to an embodiment, a unique service of the transmitted packet may be identified based on the INT flow identifier (e.g., the S-NSSAI, the QoS flow identifier, the PDU session IP address) and the sequence number.

Referring to FIG. 7, the INT information may include at least one of fields for the latency or Tput quality measurement. According to various embodiments of the disclosure, other path quality metrics such as packet loss rate may be provided by extending the INT field. According to an embodiment, a time stamp value may be transmitted and received in packet transmission per path to measure the latency quality. A DL sending time stamp value may be a time stamp value set by each node at the transmission, if a packet is transmitted in the DL direction. A UL sending time stamp may be a time stamp value set by each node at the transmission, if transmitting a packet in the UL direction. N3, F1-U, and air delay result fields per segment may be values calculated using a difference between the INT time stamp value received by each node, and a local time of each node. The N3, F1-U, and air delay result fields per segment may be set before transmitting the packet to a next node. For example, the CU-UP 130 may calculate DL delay by comparing the INT DL sending time stamp value received from the UPF 140 with its own local time stamp value. The CU-UP 130 may set a DL delay calculation result in the DL N3 delay result. If transmitting a packet to the DU 120, the CU-UP 130 may transmit an INT header including DL N3 delay result information which is set by the CU-UP 130 in a GTP-U extension header.

The Tput quality may be measured using the measured latency information and bytes of the packet transmitted and received. DL payload bytes and UL payload bytes of the INT may indicate bytes of actually transmitted/received packets. The payload bytes field is set by a node which initially inserts the INT. For example, in the packet transmission of the DL direction, the node initially inserting the INT may be the UPF 140. The UPF 140 may transmit the INT by inserting payload bytes information based on the transmitted packet amount into the INT. Each node may identify the packet amount based on the payload bytes information included in the received INT. Each node may measure the quality related to the Tput based on the identified packet amount and the latency per segment.

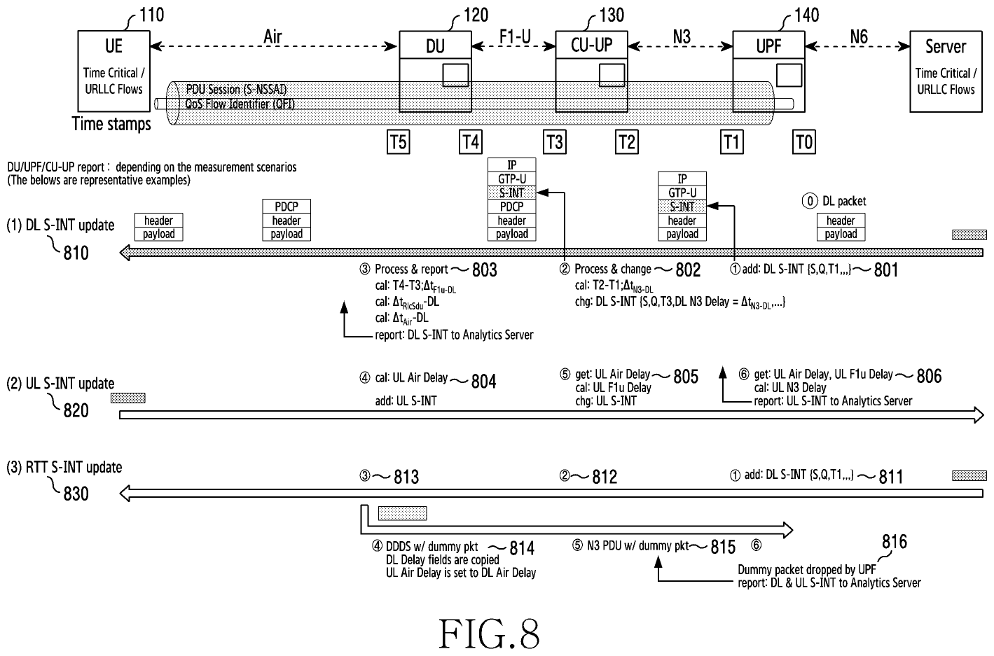

FIG. 8 illustrates an example of path quality measurement and reporting per entity based on latency according to an embodiment of the disclosure. Specifically, FIG. 8 shows the example of the latency quality measurement in each of DL transmission, UL transmission, and RTT transmission of packets.

Referring to FIG. 8, (1) a DL INT update situation 810, (2) a UL INT update situation 820 and (3) an RTT INT update situation 830 are illustrated. According to various embodiments of the disclosure, referring to FIG. 8, although the S-INT is depicted, this may also be referred to as the INT, and the INT may have an equivalent meaning to the S-INT.

Referring to FIG. 8, (1) the DL INT update 810 shows DL delay quality measuring, transmitting and reporting operations per segment based on the INT. The quality measurement of the DL path delay may be performed by each of the UPF 140, the CU-UP 130, and the DU 120, in traffic transmission from the UPF 140 to the UE 110.

In operation 801, the UPF 140 may identify traffic for a slice and a service to monitor. The UPF 140 may identify a service for transmitting a packet based on the traffic for the identified slice and service. The UPF 140 may set INT and QoS flow identifier values of the INT header to correspond to the identified service. With respect to the transmitted packet, the UPF 140 may set other field value of the INT (set the INT flag, etc.) than the QoS flow identifier value, and set the unidirectional DL delay ind flag. The UPF 140 may set the DL sending time stamp value before transmitting the packet to the CU-UP 130. According to an embodiment, the DL delay measurement segment may be set to RAN only, rather than RAN 150+CN 160, based on the INT operation setting of the operator. If the DL delay measurement segment is set to RAN only, the CU-UP 130 may serve as an endpoint and only the latency of the RAN 150 segment may be measured.

In operation 802, the CU-UP 130 may determine presence or absence of the INT header from the GTP-U packet received from the UPF 140. If the INT is included in the received packet, the CU-UP 130 may measure the transmission quality. The CU-UP 130 may perform unidirectional DL delay measurement using field information in the INT header. The CU-UP 130 may calculate DL N3 delay, through the INT header information received from the UPF 140. According to an embodiment, a DL N3 delay value may be set based on the difference between the local time of the CU-UP 130 and the DL sending time stamp value set by the UPF 140 included in the received INT header. The CU-UP 130 may update the calculated DL N3 delay to the INT header before transmitting the received packet to the DU 120. The CU-UP 130 may update the DL sending time stamp with the transmission time to the DU 120. According to an embodiment, the entities of the DU 120, the CU-UP 130 and the UPF 140 may perform time synchronization through network time protocol (NTP) v4 synchronization. Referring to FIG. 8, in operation 802, it is illustrated that the CU-UP 130 transmits the updated INT information to the DU 120 without reporting it to the upper layer, but it is not limited thereto. According to an embodiment of the disclosure, based on an INT report policy set by the operator, the CU-UP 130 may directly report the updated INT information to the higher network slice analytics.

In operation 803, the DU 120 may determine presence or absence of the INT header from the GTP-U packet received from the CU-UP 130. If the INT is included in the received packet, the DU 120 may measure the transmission quality. The DU 120 may calculate DL F1-U delay, through the INT header information received from the CU-UP 130. According to an embodiment, a DL F1-U delay value may be set based on the difference between the local time of the DU 120 and the DL sending time stamp value updated by the CU-UP 130 included in the received INT header. The DU 120 may transmit the received packet to the UE 110. The DU 120 may measure DL air delay. The DU 120 may update the measured DL air delay and the calculated DL F1-U delay to the INT header. The DU 120 may update the DL sending time stamp with the transmission time to the UE 110. According to an embodiment, the entities of the DU 120, the CU-UP 130 and the UPF 140 may perform the time synchronization through the NTPv4 synchronization. According to an embodiment of the disclosure, based on the INT report policy set by the operator, the DU 120 may report the updated INT information to the higher network slice analytics.

Referring to FIG. 8, (2) the UL INT update 820 shows UL delay quality measuring, transmitting, and reporting operations per segment, based on the INT. The quality measurement of the UL path delay may be performed by each of the UPF 140, the CU-UP 130, and the DU 120, in transmitting traffic from the DU 120 to the UPF 140. According to an embodiment, the UL INT update may have a similar operation flow to the DL delay measurement of FIG. 8 (1), with only the UL direction.

In operation 804, the DU 120 may identify slice and service traffic of the UL service to transmit. The DU 120 may identify the service to transmit a packet based on the identified slice and service traffic. The DU 120 may set INT and QoS flow identifier values of the INT header to correspond to the identified service. With respect to the transmitted packet, the DU 120 may set other field value of the INT (set the INT flag, etc.) than the QoS flow identifier value, and set the unidirectional DL delay ind flag. The DU 120 may set the UL sending time stamp value before transmitting a packet to the CU-UP 130. According to an embodiment, the UL delay measurement segment may be set to RAN only, rather than RAN 150+CN 160, based on the INT operation setting of the operator. If the UL delay measurement segment is set to RAN only, the CU-UP 130 may serve as an endpoint and only the latency of the RAN 150 segment may be measured.

In operation 805, the CU-UP 130 may determine presence or absence of the INT header from the GTP-U packet received from the DU 120. If the INT is included in the received packet, the CU-UP 130 may measure the transmission quality. The CU-UP 130 may perform unidirectional UL delay measurement using field information in the INT header. The CU-UP 130 may calculate UL F1-U delay, through the INT header information received from the DU 120. According to an embodiment, a UL F1-U delay value may be set based on the difference between the local time of the CU-UP 130 and the UL sending time stamp value set by the DU 120 included in the received INT header. The CU-UP 130 may update the calculated UL F1-U delay to the INT header, before transmitting the received packet to the UPF 140. The CU-UP 130 may update the UL sending time stamp with the transmission time to the UPF 140. According to an embodiment, the entities of the DU 120, the CU-UP 130 and the UPF 140 may perform the time synchronization through the NTPv4 synchronization. Referring to FIG. 8, in operation 805, it is illustrated, but not limited to, that the CU-UP 130 transmits the updated INT information to the UPF 140 without reporting it to the upper layer. According to an embodiment of the disclosure, based on the INT report policy set by the operator, the CU-UP 130 may directly report the updated INT information to the higher network slice analytics.

In operation 806, the UPF 140 may determine presence or absence of the INT header from the GTP-U packet received from the CU-UP 130. If the INT is included in the received packet, the UPF 140 may measure the transmission quality. According to an embodiment, the UPF 140 may perform unidirectional DL delay measurement or RTT delay measurement using the field information in the INT header. The UPF 140 may calculate UL N3 delay, through the INT header information received from the CU-UP 130. According to an embodiment, a DL N3 delay value may be set based on the difference between the local time of the UPF 140 and the UL sending time stamp value updated by the CU-UP 130 included in the received INT header. The UPF 140 may transmit the received packet to a destination (e.g., a data network (DN)) through N6. The UPF 140 may update the calculated UL N3 delay to the INT header. The UPF 140 may update the UL sending time stamp with the transmission time to the N6 destination. According to an embodiment, the entities of the DU 120, the CU-UP 130 and the UPF 140 may perform the time synchronization through the NTPv4 synchronization. According to an embodiment of the disclosure, based on the INT report policy set by the operator, the UPF 140 may report the updated INT information to the higher network slice analytics.

Referring to FIG. 8, (3) the RTT INT update 830 illustrates INT-based RTT delay quality measuring, transmitting, and reporting operations per segment. The DL and UL RTT path delay quality may be performed by the UPF 140, the CU-UP 130, and the DU 120 respectively, in transmitting traffic from the UPF 140 to the UE 110.

In operation 811, the UPF 140 may identify traffic for a slice and a service to monitor. The UPF 140 may identify the service for transmitting a packet based on the identified slice and service traffic. The UPF 140 may set INT and QoS flow identifier values of the INT header to correspond to the identified service. With respect to the transmitted packet, the UPF 140 may set other field value of the INT (set the INT flag, etc.) than the QoS flow identifier value, and set the unidirectional DL delay ind flag. The UPF 140 may set the DL sending time stamp value before transmitting the packet to the CU-UP 130. According to an embodiment, the DL delay measurement segment may be set to RAN only, rather than RAN 150+CN 160, based on the INT operation setting of the operator. If the DL delay measurement segment is set to RAN only, the CU-UP 130 may serve as an endpoint and only the latency of the RAN 150 segment may be measured.

In operation 812, the CU-UP 130 may determine presence or absence of the INT header from the GTP-U packet received from the UPF 140. If the INT is included in the received packet, the CU-UP 130 may measure the transmission quality. The CU-UP 130 may perform unidirectional DL delay measurement using the field information in the INT header. The CU-UP 130 may calculate DL N3 delay, through the INT header information received from the UPF 140. According to an embodiment, a DL N3 delay value may be set based on the difference between the local time of the CU-UP 130 and the DL sending time stamp value set by the UPF 140 and included in the received INT header. The CU-UP 130 may update the calculated DL N3 delay to the INT header, before transmitting the received packet to the DU 120. The CU-UP 130 may update the DL sending time stamp with the transmission time to the DU 120. According to an embodiment, the entities of the DU 120, the CU-UP 130 and the UPF 140 may perform the time synchronization through the NTPv4 synchronization. Referring to FIG. 8, in operation 812, it is illustrated, but not limited to, that the CU-UP 130 transmits the updated INT information to the DU 120 without reporting it to the upper layer. According to an embodiment of the disclosure, based on the INT report policy set by the operator, the CU-UP 130 may directly report the updated INT information to the higher network slice analytics.

In operation 813, the DU 120 may determine presence or absence of the INT header from the GTP-U packet received from the CU-UP 130. If the INT is included in the received packet, the DU 120 may measure the transmission quality. The DU 120 may calculate DL F1-U delay, through the INT header information received from the CU-UP 130. According to an embodiment, a DL F1-U delay value may be set based on the difference between the local time of the DU 120 and the DL sending time stamp value updated by the CU-UP 130 and included in the received INT header. The DU 120 may transmit the received packet to the UE 110. The DU 120 may measure DL air delay. The DU 120 may update the measured DL air delay, and the calculated DL F1-U delay to the INT header. The DU 120 may update the DL sending time stamp with the transmission time to the UE 110. According to an embodiment, the entities of the DU 120, the CU-UP 130 and the UPF 140 may perform the time synchronization through the NTPv4 synchronization. According to an embodiment of the disclosure, based on the INT report policy set by the operator, the DU 120 may report the updated INT information to the higher network slice analytics.

In operation 814, the DU 120 may identify slice and service traffic of the UL service to transmit. The DU 120 may identify the service for transmitting the packet based on the identified slice and service traffic. If measuring the RTT transmission quality, the UL direction may have no traffic. If measuring the RTT transmission quality, the DU 120 may generate and transmit a dummy packet in the UL direction, after finishing transmission of the DL packet received from the CU-UP 130 to the UE 110. A reflector included in the DU 120 may copy the DL INT information received by the DU 120 together with the DL packet to the UL INT, if generating the UL dummy packet. In the RTT delay quality measurement, the reflector of DU 120 may be generated by copying corresponding field values of the received DL INT header with respect to the INT, QoS flow identifier, INT sequence number, DL N3 Delay, and F1-U Delay values of the UL INT header. According to an embodiment, the RTT transmission quality measurement uses merely the dummy packet, and may have the operation flow similar to the UL delay measurement of FIG. 8 (2). The DU 120 may set the INT and QoS flow identifier values of the INT header to correspond to the identified service. The DU 120 may set other INT field value than the QoS flow identifier value for the transmitted packet, (set the INT flag, etc.) and set a unidirectional UL delay ind flag. The DU 120 may set the UL sending time stamp value before transmitting the packet to the CU-UP 130. According to an embodiment, the UL delay measurement segment may be set to RAN Only, rather than RAN 150+CN 160, based on the INT operation setting of the operator. If the UL delay measurement segment is set to RAN only, the CU-UP 130 may serve as an endpoint and only the latency of the RAN 150 segment may be measured.

In operation 815, the CU-UP 130 may determine presence or absence of the INT header from the GTP-U packet received from the DU 120. If the INT is included in the received packet, the CU-UP 130 may measure the transmission quality. The CU-UP 130 may perform unidirectional UL delay measurement using the field information in the INT header. The CU-UP 130 may calculate UL F1-U delay, through the INT header information received from the DU 120. According to an embodiment, a UL F1-U delay value may be set based on the difference between the local time of the CU-UP 130 and the UL sending time stamp value set by the DU 120 and included in the received INT header. The CU-UP 130 may update the calculated UL F1-U delay to the INT header, before transmitting the received packet to the UPF 140. The CU-UP 130 may update the UL sending time stamp with the transmission time to the UPF 140. According to an embodiment, the entities of the DU 120, the CU-UP 130 and the UPF 140 may perform the time synchronization through the NTPv4 synchronization. Referring to FIG. 8, in operation 805, it is illustrated, but not limited to, that the CU-UP 130 transmits the updated INT information to the UPF 140 without reporting it to the upper layer. According to an embodiment of the disclosure, based on the INT report policy set by the operator, the CU-UP 130 may directly report the updated INT information to the higher network slice analytics.

In operation 816, the UPF 140 may determine presence or absence of the INT header from the GTP-U packet received from the CU-UP 130. If the INT is included in the received packet, the UPF 140 may measure the transmission quality. According to an embodiment, the UPF 140 may perform unidirectional DL delay measurement or RTT delay measurement using the field information in the INT header. The UPF 140 may calculate UL N3 delay, through the INT header information received from the CU-UP 130. According to an embodiment, a DL N3 delay value may be set based on the difference between the local time of the UPF 140 and the UL sending time stamp value updated by the CU-UP 130 and included in the received INT header. The UPF 140 may transmit the received packet to a destination (e.g., a DN) through N6. The UPF 140 may update the calculated UL N3 delay to the INT header. The UPF 140 may update the UL sending time stamp with the transmission time to the N6 destination. According to an embodiment, the entities of the DU 120, the CU-UP 130 and the UPF 140 may perform the time synchronization through the NTPv4 synchronization. According to an embodiment of the disclosure, based on the INT report policy set by the operator, the UPF 140 may report the updated INT information to the higher network slice analytics.

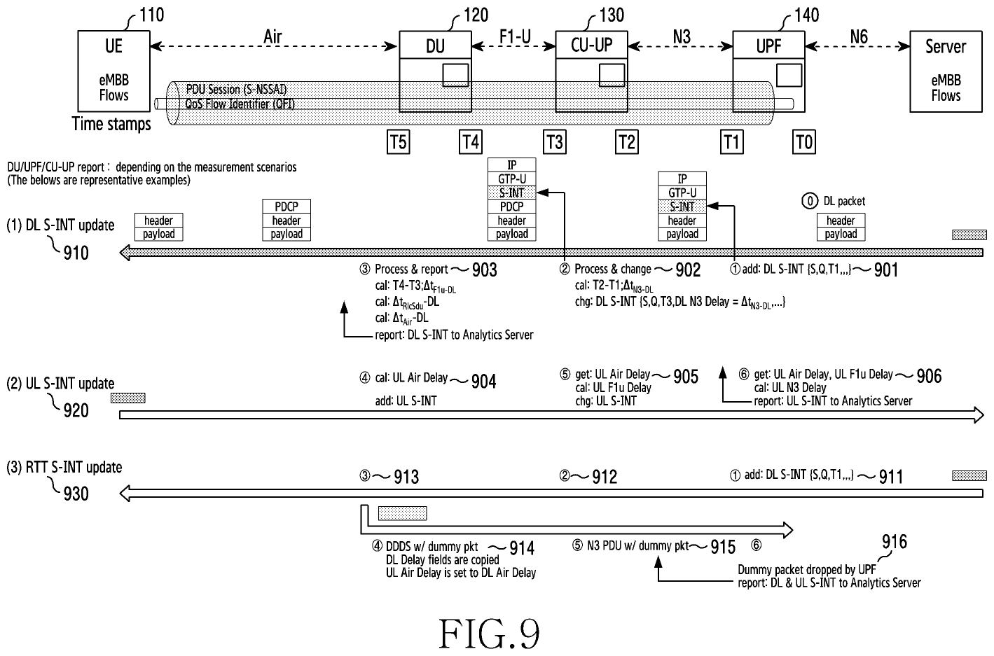

FIG. 9 illustrates an example of path quality measurement and report per entity based on Tput according to an embodiment of the disclosure. Specifically, FIG. 9 shows the Tput quality measurement example in packet DL transmission, UL transmission, and RTT transmission.

Referring to FIG. 9, (1) a DL INT update situation 910, (2) a UL INT update situation 920 and (3) an RTT INT update situations 930 are illustrated. According to various embodiments of the disclosure, referring to FIG. 9, although the S-INT is illustrated, it may also be referred to as the INT, and the INT may have an equivalent meaning to the S-INT.

According to various embodiments of the disclosure, an operation flow in the packet transmission may be the same as the delay quality measurement operations shown in FIG. 8. According to an embodiment, a single packet transmission Tput value may be calculated as [bytes transmitted/DL delay time or UL delay time]. For transmission of multiple packets, the Tput value may be calculated as [sum of bytes/sum of delay time] or average of the single packet transmission Tput. According to various embodiments of the disclosure, this is merely an example and is not limited thereto, and the two values may be simultaneously calculated according to a network slice analytics policy set by the operator.

Referring to FIG. 9, (1) the DL INT update 910 shows DL delay quality measuring, transmitting and reporting operations per segment based on the INT. The quality measurement of the DL path latency may be performed by each of the UPF 140, the CU-UP 130, and the DU 120, in transmitting traffic from the UPF 140 to the UE 110.

In operation 901, the UPF 140 may identify traffic for a slice and a service to monitor. The UPF 140 may identify a service for transmitting a packet based on the traffic for the identified slice and service. The UPF 140 may set INT and QoS flow identifier values of the INT header to correspond to the identified service. With respect to the transmitted packet, the UPF 140 may set other field value of the INT (set the INT flag, etc.) than the QoS flow identifier value, and set a unidirectional DL delay ind flag. The UPF 140 may set a DL sending time stamp value before transmitting a packet to the CU-UP 130. According to an embodiment, the DL delay measurement segment may be set to RAN only, rather than RAN 150+CN 160, based on the INT operation setting of the operator. If the DL delay measurement segment is set to RAN only, the CU-UP 130 may serve as an endpoint and only the latency of the RAN 150 segment may be measured.

In operation 902, the CU-UP 130 may determine presence or absence of the INT header from the GTP-U packet received from the UPF 140. If the INT is included in the received packet, the CU-UP 130 may measure the transmission quality. The CU-UP 130 may perform unidirectional DL delay measurement using field information in the INT header. The CU-UP 130 may calculate DL N3 delay, through the INT header information received from the UPF 140. According to an embodiment, a DL N3 delay value may be set based on the difference between the local time of the CU-UP 130 and the DL sending time stamp value set by the UPF 140 and included in the received INT header. The CU-UP 130 may update the calculated DL N3 delay to the INT header, before transmitting the received packet to the DU 120. The CU-UP 130 may update the DL sending time stamp with the transmission time to the DU 120. According to an embodiment, the entities of the DU 120, the CU-UP 130 and the UPF 140 may perform the time synchronization through the NTPv4 synchronization. Referring to FIG. 9, in operation 902, it is illustrated, but not limited to, that the CU-UP 130 transmits the updated INT information to the DU 120 without reporting it to the higher layer. According to an embodiment of the disclosure, based on the INT report policy set by the operator, the CU-UP 130 may directly report the updated INT information to the higher network slice analytics.

In operation 903, the DU 120 may determine presence or absence of the INT header from the GTP-U packet received from the CU-UP 130. If the INT is included in the received packet, the DU 120 may measure the transmission quality. The DU 120 may calculate DL F1-U delay, through the INT header information received from the CU-UP 130. According to an embodiment, a DL F1-U delay value may be set based on the difference between the local time of the DU 120 and the DL sending time stamp value updated by the CU-UP 130 and included in the received INT header. The DU 120 may transmit the received packet to the UE 110. The DU 120 may measure DL air delay. The DU 120 may update the measured DL air delay, and the calculated DL F1-U delay to the INT header. The DU 120 may update the DL sending time stamp with the transmission time to the UE 110. According to an embodiment, the entities of the DU 120, the CU-UP 130 and the UPF 140 may perform the time synchronization through the NTPv4 synchronization. According to an embodiment of the disclosure, based on the INT report policy set by the operator, the DU 120 may report the updated INT information to the higher network slice analytics. According to an embodiment, the DU 120 may calculate a Tput value for the DL based on the measured delay information and payload bytes information included in the INT header information. The DU 120 may report the measured Tput value to the higher network slice analytics. However, various embodiments of the disclosure are not limited thereto, and the Tput value calculation may be performed by the higher network slice analytics.

Referring to FIG. 9, (2) the UL INT update 920 shows UL delay quality measuring, transmitting, and reporting operations per segment, based on the INT. The quality measurement of the UL path delay may be performed by the UPF 140, the CU-UP 130, and the DU 120 each, in transmitting traffic from the DU 120 to the UPF 140. According to an embodiment, the UL INT update may have a similar operation flow to the DL delay measurement of FIG. 9 (1), with only the UL direction.

In operation 904, the DU 120 may identify traffic for a slice and a service for transmitting the UL service. The DU 120 may identify the service for transmitting the packet based on the identified slice and service traffic. The DU 120 may set INT and QoS flow identifier values of the INT header to correspond to the identified service. With respect to the transmitted packet, the DU 120 may set other field value of the INT (set the INT flag, etc.) than the QoS flow identifier value, and set the unidirectional DL delay ind flag. The DU 120 may set a UL sending time stamp value before transmitting the packet to the CU-UP 130. According to an embodiment, the UL delay measurement segment may be set to RAN only, rather than RAN 150+CN 160, based on the INT operation setting of the operator. If the UL delay measurement segment is set to RAN only, the CU-UP 130 may serve as an endpoint and only the latency of the RAN 150 segment may be measured.

In operation 905, the CU-UP 130 may determine presence or absence of the INT header from the GTP-U packet received from the DU 120. If the INT is included in the received packet, the CU-UP 130 may measure the transmission quality. The CU-UP 130 may perform unidirectional UL delay measurement using the field information in the INT header. The CU-UP 130 may calculate UL F1-U delay, through the INT header information received from the DU 120. According to an embodiment, a UL F1-U delay value may be set based on the difference between the local time of the CU-UP 130 and the UL sending time stamp value set by the DU 120 and included in the received INT header. The CU-UP 130 may update the calculated UL F1-U delay to the INT header, before transmitting the received packet to the UPF 140. The CU-UP 130 may update the UL sending time stamp with the transmission time to the UPF 140. According to an embodiment, the entities of the DU 120, the CU-UP 130 and the UPF 140 may perform the time synchronization through the NTPv4 synchronization. Referring to FIG. 9, in operation 905, it is illustrated, but not limited to, that the CU-UP 130 transmits the updated INT information to the UPF 140 without reporting it to the higher layer. According to an embodiment of the disclosure, based on the INT report policy set by the operator, the CU-UP 130 may directly report the updated INT information to the higher network slice analytics.

In operation 906, the UPF 140 may determine presence or absence of the INT header from the GTP-U packet received from the CU-UP 130. If the INT is included in the received packet, the UPF 140 may measure the transmission quality. According to an embodiment, the UPF 140 may perform unidirectional DL delay measurement or RTT delay measurement using the field information in the INT header. The UPF 140 may calculate UL N3 delay, through the INT header information received from the CU-UP 130. According to an embodiment, a DL N3 delay value may be set based on the difference between the local time of the UPF 140 and the UL sending time stamp value updated by the CU-UP 130 and included in the received INT header. The UPF 140 may transmit the received packet to a destination (e.g., a DN) through N6. The UPF 140 may update the calculated UL N3 delay to the INT header. The UPF 140 may update the UL sending time stamp with the transmission time to the N6 destination. According to an embodiment, the entities of the DU 120, the CU-UP 130 and the UPF 140 may perform the time synchronization through the NTPv4 synchronization. According to an embodiment of the disclosure, based on the INT report policy set by the operator, the UPF 140 may report the updated INT information to the higher network slice analytics. According to an embodiment, the UPF 140 may calculate a Tput value for the DL based on the measured delay information and the payload bytes information included in the INT header information. The UPF 140 may report the measured Tput value to the higher network slice analytics. However, various embodiments of the disclosure are not limited thereto, and the Tput value calculation may be performed by the higher network slice analytics.

Referring to FIG. 9, (3) the RTT INT update 930 illustrates INT-based RTT delay quality measuring, transmitting, and reporting operations per segment. The DL and UL RTT path delay quality may be performed by the UPF 140, the CU-UP 130, and the DU 120, in transmitting traffic from the UPF 140 to the UE 110.

In operation 911, the UPF 140 may identify traffic for the slice and the service to monitor. The UPF 140 may identify the service for transmitting a packet based on the identified slice and service traffic. The UPF 140 may set INT and QoS flow identifier values of the INT header to correspond to the identified service. With respect to the transmitted packet, the UPF 140 may set other field value of the INT (set the INT flag, etc.) than the QoS flow identifier value, and set the unidirectional DL delay ind flag. The UPF 140 may set a DL sending time stamp value before transmitting the packet to the CU-UP 130. According to an embodiment, the DL delay measurement segment may be set to RAN only, rather than RAN 150+CN 160, based on the INT operation setting of the operator. If the DL delay measurement segment is set to RAN only, the CU-UP 130 may serve as an endpoint and only the latency of the RAN 150 segment may be measured.

In operation 912, the CU-UP 130 may determine INT header presence or absence from the GTP-U packet received from the UPF 140. If the INT is included in the received packet, the CU-UP 130 may measure the transmission quality. The CU-UP 130 may perform unidirectional DL delay measurement using the field information in the INT header. The CU-UP 130 may calculate DL N3 delay, through the INT header information received from the UPF 140. According to an embodiment, a DL N3 delay value may be set based on the difference between the local time of the CU-UP 130 and the DL sending time stamp value set by the UPF 140 and included in the received INT header. The CU-UP 130 may update the calculated DL N3 delay to the INT header, before transmitting the received packet to the DU 120. The CU-UP 130 may update the DL sending time stamp with the transmission time to the DU 120. According to an embodiment, the entities of the DU 120, the CU-UP 130 and the UPF 140 may perform the time synchronization through the NTPv4 synchronization. Referring to FIG. 9, in operation 912, it is illustrated, but not limited to, that the CU-UP 130 transmits the updated INT information to the DU 120 without reporting it to the higher layer. According to an embodiment of the disclosure, based on the INT report policy set by the operator, the CU-UP 130 may directly report the updated INT information to the higher network slice analytics.

In operation 913, the DU 120 may determine INT header presence or absence from the GTP-U packet received from the CU-UP 130. If the INT is included in the received packet, the DU 120 may measure the transmission quality. The DU 120 may calculate DL F1-U delay, through the INT header information received from the CU-UP 130. According to an embodiment, a DL F1-U delay value may be set based on the difference between the local time of the DU 120 and the DL sending time stamp value updated by the CU-UP 130 and included in the received INT header. The DU 120 may transmit the received packet to the UE 110. The DU 120 may measure DL air delay. The DU 120 may update the measured DL air delay, and the calculated DL F1-U delay to the INT header. The DU 120 may update the DL sending time stamp with the transmission time to the UE 110. According to an embodiment, the entities of the DU 120, the CU-UP 130 and the UPF 140 may perform the time synchronization through the NTPv4 synchronization. According to an embodiment of the disclosure, based on the INT report policy set by the operator, the DU 120 may report the updated INT information to the higher network slice analytics. According to an embodiment, the DU 120 may calculate the Tput value for the DL based on the measured delay information and the payload bytes information included in the INT header information. The DU 120 may report the measured Tput value to the higher network slice analytics. However, various embodiments of the disclosure are not limited thereto, and the Tput value calculation may be performed by the higher network slice analytics.

In operation 914, the DU 120 may identify slice and service traffic of the UL service to transmit. The DU 120 may identify the service for transmitting the packet based on the identified slice and service traffic. If measuring the RTT transmission quality, the UL direction may have no traffic. If measuring the RTT transmission quality, the DU 120 may generate and transmit a dummy packet in the UL direction, after completing transmission of the DL packet received from the CU-UP 130 to the UE 110. The reflector included in the DU 120 may copy the DL INT information received by the DU 120 together with the DL packet to the UL INT, if generating a UL dummy packet. In the RTT delay quality measurement, the reflector of DU 120 may be generated by copying corresponding field values of the received DL INT header with respect to the INT, QoS flow identifier, INT sequence number, DL N3 delay, and F1-U delay values of the UL INT header. According to an embodiment, the RTT transmission quality measurement uses merely the dummy packet, and may have a similar operation flow to the UL delay measurement of the situation (2) of FIG. 9. The DU 120 may set the INT and QoS flow identifier values of the INT header to correspond to the identified service. With respect to the transmitted packet, the DU 120 may set other INT field value than the QoS flow identifier value (set the INT flag, etc.) and may set the unidirectional UL delay ind flag. The DU 120 may set the UL sending time stamp value before transmitting the packet to the CU-UP 130. According to an embodiment, the UL delay measurement segment may be set to RAN Only, rather than RAN 150+CN 160, based on the INT operation setting of the operator. If the UL delay measurement segment is set to RAN Only, the CU-UP 130 may serve as an endpoint and only the latency of the RAN 150 segment may be measured.

In operation 915, the CU-UP 130 may determine INT header presence or absence from the GTP-U packet received from the DU 120. If the INT is included in the received packet, the CU-UP 130 may measure the transmission quality. The CU-UP 130 may perform unidirectional UL delay measurement using the field information in the INT header. The CU-UP 130 may calculate UL F1-U delay, through the INT header information received from the DU 120. According to an embodiment, a UL F1-U delay value may be set based on the difference between the local time of the CU-UP 130 and the UL sending time stamp value set by the DU 120 and included in the received INT header. The CU-UP 130 may update the calculated UL F1-U delay to the INT header, before transmitting the received packet to the UPF 140. The CU-UP 130 may update the UL sending time stamp with the transmission time to the UPF 140. According to an embodiment, the entities of the DU 120, the CU-UP 130 and the UPF 140 may perform the time synchronization through the NTPv4 synchronization. Referring to FIG. 9, in operation 905, it is illustrated, but not limited to, that the CU-UP 130 transmits the updated INT information to the UPF 140 without reporting it to the higher layer. According to an embodiment of the disclosure, based on the INT report policy set by the operator, the CU-UP 130 may report the updated INT information directly to the higher network slice analytics.

In operation 916, the UPF 140 may determine INT header presence or absence from the GTP-U packet received from the CU-UP 130. If the INT is included in the received packet, the UPF 140 may measure the transmission quality. According to an embodiment, the UPF 140 may perform unidirectional DL delay measurement or RTT delay measurement using the field information in the INT header. The UPF 140 may calculate UL N3 delay, through the INT header information received from the CU-UP 130. According to an embodiment, a DL N3 delay value may be set based on the difference between the local time of the UPF 140 and the UL sending time stamp value updated by the CU-UP 130 and included in the received INT header. The UPF 140 may transmit the received packet to a destination (e.g., a DN) through N6. The UPF 140 may update the calculated UL N3 delay to the INT header. The UPF 140 may update the UL sending time stamp with the transmission time to the N6 destination. According to an embodiment, the entities of the DU 120, the CU-UP 130 and the UPF 140 may perform the time synchronization through the NTPv4 synchronization. According to an embodiment of the disclosure, based on the INT report policy set by the operator, the UPF 140 may report the updated INT information to the higher network slice analytics. According to an embodiment, the UPF 140 may calculate the Tput value for the DL based on the measured delay information and the payload bytes information included in the INT header information. The UPF 140 may report the measured Tput value to the higher network slice analytics. However, various embodiments of the disclosure are not limited thereto, and the Tput value calculation may be performed by the higher network slice analytics.

According to an embodiment, the UPF 140 may calculate the Tput value for the DL based on the measured delay information and the payload bytes information included in the INT header information. The UPF 140 may report the measured Tput value to the higher network slice analytics. However, various embodiments of the disclosure are not limited thereto, and the Tput value calculation may be performed by the higher network slice analytics.

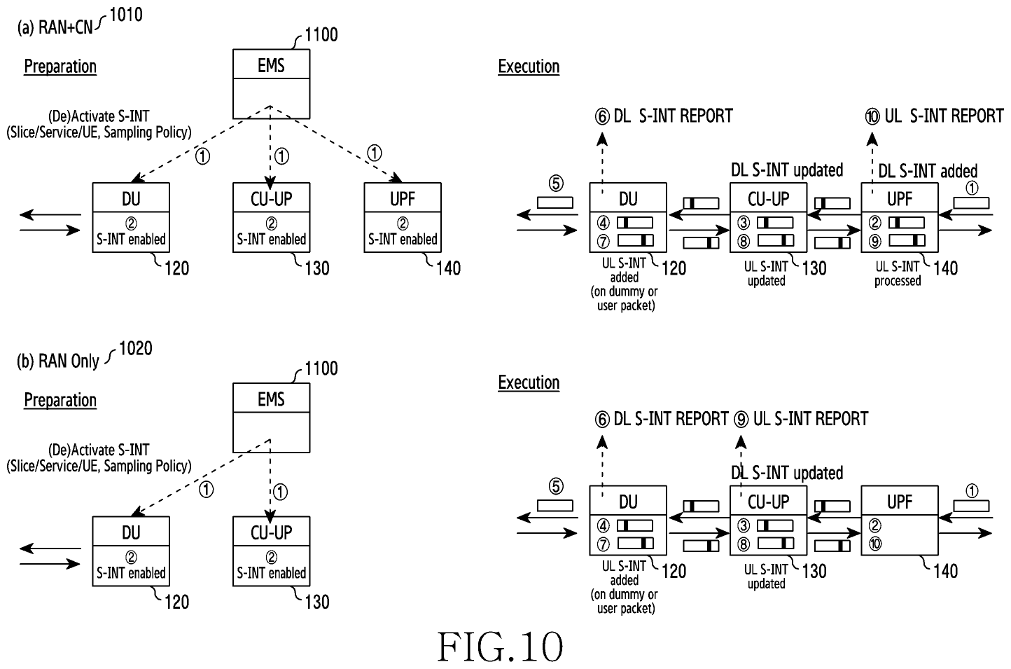

FIG. 10 illustrates an example of network entities including an element management system (EMS) which measures and reports quality per path according to an embodiment of the disclosure. Specifically, FIG. 10 illustrates the example of INT measurement preparation and execution procedures per node. An EMS 1100 may transmit configuration information of operations performed by nodes which transmit and receive packets to each of the nodes.

According to various embodiments of the disclosure, referring to FIG. 10, although the S-INT is illustrated, it may also be referred to as the INT, and the INT may have an equivalent meaning to the S-INT.

According to an embodiment, in the preparation operation, the EMS may indicate the INT measurement direction of the DU, the UL, or the RTT for a target slice or service (e.g., (de)activate command) to each of the nodes. The EMS may also indicate a sampling cycle as a quality measurement related parameter. The EMS may instruct execution of the quality measurement, by transmitting to each of the nodes configuration information including an indicator for each instruction target. According to an embodiment, in the execution operation, the nodes each may perform an INT related GTP-U next header and INT header insertion operation on a GTP-U path actually transmitting a packet. The nodes each may perform the INT-based latency and Tput measurement operation and reporting operation described in FIG. 8 and FIG. 9.

If releasing the INT measurement, the EMS may perform a deactivate procedure and thus indicate INT measurement abortion for a specific slice or service to each of the nodes. In the same manner as the preparation operation, the EMS may instruct to stop the quality measurement, by transmitting the configuration information including an indicator related to the measurement abortion to each of the nodes.

According to an embodiment, the EMS may designate an INT segment for performing the quality measurement and reporting. Referring to FIG. 10, according to an embodiment, part (a) of FIG. 10 shows the RAN+CN segment 1010. In this case, the segment end points of the INT path delay quality may be the DU and the UPF. In part (a) of FIG. 10, the quality measurement report using the INT may be performed by at least one of the DU 120, the CU-UP 130, or the UPF 140. According to an embodiment, part (b) of FIG. 10 shows the RAN only segment 1020. In this case, the endpoints may be the DU and the CU-UP. In part (b) of FIG. 10, the quality measurement report using the INT may be performed by at least one of the DU 120 or the CU-UP 130, and may not be performed by the UPF 140.

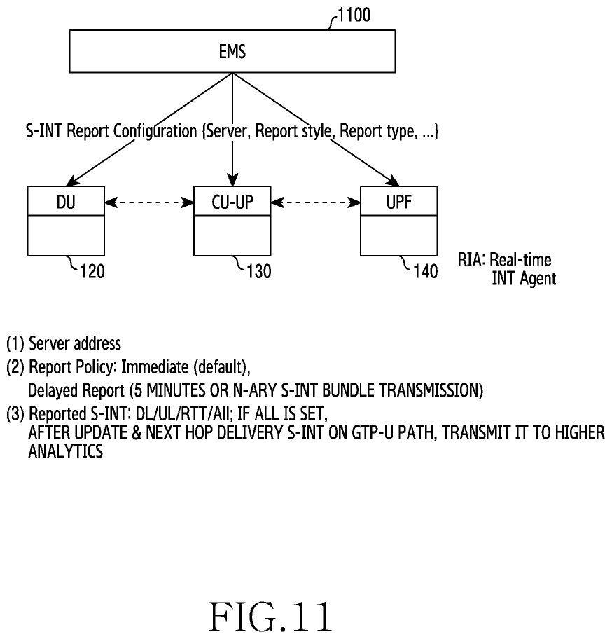

FIG. 11 illustrates an example of a procedure for configuring INT report at an EMS according to an embodiment of the disclosure. Specifically, the example of INT report configuration transmitted by the EMS to each of nodes is illustrated. The INT report configuration may be a configuration related to a function in which each node reports DL, UL, or DL/UL INT information to its higher server.

According to various embodiments of the disclosure, referring to FIG. 11, although the S-INT is illustrated, it may also be referred to as the INT, and the INT may have an equivalent meaning to the S-INT.

The EMS may indicate the following policies through a report configuration transmitted to each of the nodes. First, INT report servers of the DU, the CU-UP and the UPF may be indicated. Second, the report policy related to the INT report may be indicated. According to an embodiment, after processing the GTP-U packet, an immediate report policy (e.g., immediate report) or a delayed report policy (e.g., periodic report or N-ary INT bundle delayed report) may be indicated. Third, for the DL/UL/RTT INT header collected at each node, each report type may be set. According to an embodiment, if the report type is set to all, each node may report every INT measurement result transmitted and received to the designated network slice analytics. According to various embodiments of the disclosure, the nodes each may generate INT report information to transmit to the higher layer based on the report configuration received from the EMS. The nodes each may report the quality measurement information by transmitting the generated INT report information to the higher layer (e.g., the near RT RIC, the near RAN+CN intelligent controller, the network slice analytics) in the manner according to FIGS. 8 to 11.

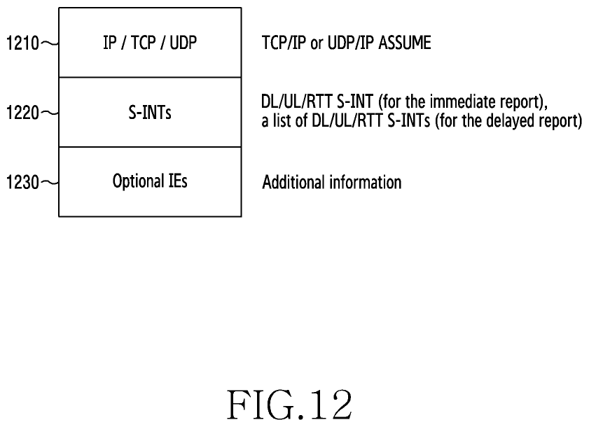

FIG. 12 illustrates an example of a protocol according to an embodiment of the disclosure.

According to an embodiment of the disclosure, referring to FIG. 12, although the S-INT 1220 is illustrated, it may also be referred to as the INT, and the INT may have an equivalent meaning to the S-INT.

Referring to FIG. 12, the transmission protocol between the DU 120/CU-UP 130/UPF 140 and a network slice analytics 410 may use general transmission control protocol (TCP)/internet protocol (IP) or user datagram protocol (UDP)/IP 1210. A transmitted PDU may include a single INT or a plurality of INTs.

If the report configuration is the immediate report policy, the PDU may contain a single INT. In the delayed report policy, the PDU may include a plurality of INTs.

The INT PDU may include additional information 1230 in addition to the measured path delay quality. The additional information 1230 is specific information per node and may include a network function (NF) identifier of each node. The additional information 1230 may include a cell ID or a base station extension ID of each node. The additional information 1230 may include cell information related to the slice or the service to be measured in the quality. The additional information 1230 may include air and RF QoS information and a PDU session IP address related to the target UE 110.

According to various embodiments of the disclosure, a method performed by a CU-UP in a wireless communication system may include receiving information related to packet transmission from a UPF, the information related to the packet transmission including a QoS flow provided, a slice provided with the QoS flow, an indicator indicating a terminal for receiving the QoS flow and a time parameter related to latency quality measurement, identifying a quality measurement value based on the received information related to the packet transmission, updating the received information related to the packet transmission based on the identified quality measurement value, and transmitting the updated information related to the packet transmission to a DU.

According to an embodiment of the disclosure, the method performed by the CU-UP may further include generating report information based on the updated information related to the packet transmission, and transmitting the generated report information to a higher layer entity.

According to an embodiment of the disclosure, the report information may include at least one of information of a server used by the CU-UP, report policy information, and report type information.

According to an embodiment of the disclosure, the higher layer entity may include an entity relating to at least one of a near RT RIC, a near RAN+CN intelligent controller or a network slice analytics.

According to an embodiment of the disclosure, the received information related to the packet transmission may include at least one of time stamp information generated by the UPF or payload bytes information relating to a packet transmission amount.

According to an embodiment of the disclosure, the quality measurement value may be a quality measurement value related to packet transmission latency generated based on a local time value of the CU-UP.

According to an embodiment of the disclosure, the method performed by the CU-UP may further include calculating a packet transmission throughput based on the quality measure value and the payload bytes, and identifying a quality measurement value for the throughput based on the calculated packet transmission throughput.

According to an embodiment of the disclosure, the method performed by the CU-UP may further include receiving a dummy packet generated by the DU from the DU, and transmitting the received dummy packet to the UPF, and the dummy packet may be generated based on the updated packet transmission information.

According to various embodiments of the disclosure, a method performed by an EMS entity in a wireless communication system may include transmitting configuration information of information related to packet transmission to a CU-UP, and the configuration information of the packet transmission information may include information related to at least one of a server address indication related to the CU-UP, a report policy indication, or a report type indication.

According to an embodiment of the disclosure, the method performed by the EMS entity may further include transmitting configuration information of quality measurement release to the CU-UP, the report policy may indicate at least one of an immediate report policy or a delayed report policy, and the report type may indicate whether the CU-UP reports to a higher layer entity.

According to various embodiments of the disclosure, a CU-UP in a wireless communication system may include at least one processor configured to receive information related to packet transmission from a UPF, the information related to the packet transmission including a QoS flow provided, a slice provided with the QoS flow, an indicator indicating a terminal for receiving the QoS flow and a time parameter related to latency quality measurement, identify a quality measurement value based on the received information related to the packet transmission, update the received information related to the packet transmission based on the identified quality measurement value, and transmit the updated information related to the packet transmission to a DU.

According to an embodiment of the disclosure, the CU-UP may include the at least one processor configured further to generate report information based on the updated information related to the packet transmission, and transmit the generated report information to a higher layer entity.

According to an embodiment of the disclosure, the report information may include at least one of information of a server used by the CU-UP, report policy information, and report type information.

According to an embodiment of the disclosure, the higher layer entity may include an entity relating to at least one of a near RT RIC, a near RAN+CN intelligent controller or a network slice analytics.

According to an embodiment of the disclosure, the received information related to the packet transmission may include at least one of time stamp information generated by the UPF or payload bytes information relating to a packet transmission amount.

According to an embodiment of the disclosure, the quality measurement value may be a quality measurement value related to packet transmission latency generated based on a local time value of the CU-UP.

According to an embodiment of the disclosure, the CU-UP may include the at least one processor configured further to calculate a packet transmission throughput based on the quality measure value and the payload bytes, and identify a quality measurement value for the throughput based on the calculated packet transmission throughput.

According to an embodiment of the disclosure, the CU-UP may be configured further to receive a dummy packet generated by the DU from the DU, and transmit the received dummy packet to the UPF, and the dummy packet may be generated based on the updated packet transmission information.

According to various embodiments of the disclosure, an EMS entity in a wireless communication system may include at least one processor configured to transmit configuration information of information related to packet transmission to a CU-UP, and the configuration information of the packet transmission information may include information related to at least one of a server address indication related to the CU-UP, a report policy indication, or a report type indication.

According to an embodiment of the disclosure, the EMS entity may include the at least one processor configured further to transmit configuration information of quality measurement release to the CU-UP, the report policy may indicate at least one of an immediate report policy or a delayed report policy, and the report type may indicate whether the CU-UP reports to a higher layer entity.

According to various embodiments of the disclosure, a method performed by a CU-UP in a wireless communication system may include receiving information related to packet transmission from a DU, the information related to the packet transmission including a QoS flow provided, a slice provided with the QoS flow, an indicator indicating a terminal for receiving the QoS flow and a time parameter related to latency quality measurement, identifying a quality measurement value based on the received information related to the packet transmission, updating the received information related to the packet transmission based on the identified quality measurement value, and transmitting the updated information related to the packet transmission to a UPF.

According to an embodiment of the disclosure, the method performed by the CU-UP may further include generating report information based on the updated information related to the packet transmission, and transmitting the generated report information to a higher layer entity.

According to an embodiment of the disclosure, the report information may include at least one of information of a server used by the CU-UP, report policy information, and report type information.

According to an embodiment of the disclosure, the higher layer entity may be an entity relating to at least one of a near RT RIC, a near RAN+CN intelligent controller or a network slice analytics.

According to an embodiment of the disclosure, the received information related to the packet transmission may include at least one of time stamp information generated by the DU or payload bytes information relating to a packet transmission amount.

According to an embodiment of the disclosure, the quality measurement value may be a quality measurement value related to packet transmission latency generated based on a local time value of the CU-UP.

According to an embodiment of the disclosure, the method performed by the CU-UP may further include calculating a packet transmission throughput based on the quality measure value and the payload bytes, and identifying a quality measurement value for the throughput based on the calculated packet transmission throughput.

According to an embodiment of the disclosure, the method performed by the CU-UP may further include receiving a dummy packet generated by the DU from the DU, and transmitting the received dummy packet to the UPF, and the dummy packet may be generated based on the updated packet transmission information.

According to various embodiments of the disclosure, a CU-UP in a wireless communication system may include at least one processor configured to receive information related to packet transmission from a DU, the information related to the packet transmission including a QoS flow provided, a slice provided with the QoS flow, an indicator indicating a terminal for receiving the QoS flow and a time parameter related to latency quality measurement, identify a quality measurement value based on the received information related to the packet transmission, update the received information related to the packet transmission based on the identified quality measurement value, and transmit the updated information related to the packet transmission to a UPF.

According to an embodiment of the disclosure, the CU-UP may include the at least one processor configure further to generate report information based on the updated information related to the packet transmission, and transmit the generated report information to a higher layer entity.

According to an embodiment of the disclosure, the report information may include at least one of information of a server used by the CU-UP, report policy information, and report type information.

According to an embodiment of the disclosure, the higher layer entity may be an entity relating to at least one of a near RT RIC, a near RAN+CN intelligent controller or a network slice analytics.

According to an embodiment of the disclosure, the received information related to the packet transmission may include at least one of time stamp information generated by the DU or payload bytes information relating to a packet transmission amount.

According to an embodiment of the disclosure, the quality measurement value may be a quality measurement value related to packet transmission latency generated based on a local time value of the CU-UP.

According to an embodiment of the disclosure, the CU-UP may include the at least one processor configured further to calculate a packet transmission throughput based on the quality measure value and the payload bytes, and identify a quality measurement value for the throughput based on the calculated packet transmission throughput.

According to an embodiment of the disclosure, the CU-UP may include the at least one processor configured further to receive a dummy packet generated by the DU from the DU, and transmit the received dummy packet to the UPF, and the dummy packet may be generated based on the updated packet transmission information.

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to a random access memory, a non-volatile memory including a flash memory, a read only memory (ROM), an electrically erasable programmable ROM (EEPROM), a magnetic disc storage device, a compact disc (CD)-ROM, digital versatile discs (DVDs) or other optical storage devices, and a magnetic cassette. Alternatively, it may be stored to a memory combining part or all of those recording media. A plurality of memories may be included.

Also, the program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In the specific embodiments of the disclosure, the components included in the disclosure are expressed in a singular or plural form. However, the singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a central unit-user plane (CU-UP) in a wireless communication system, the method comprising:
receiving information related to packet transmission from a user plane function (UPF), the information related to the packet transmission comprising a quality of service (QoS) flow provided, a slice provided with the QoS flow, an indicator indicating a terminal for receiving the QoS flow and a time parameter related to latency quality measurement;
identifying a quality measurement value based on the received information related to the packet transmission;
updating the received information related to the packet transmission based on the identified quality measurement value; and
transmitting the updated information related to the packet transmission to a distributed unit (DU).

2. The method of claim 1, further comprising:
generating report information based on the updated information related to the packet transmission; and
transmitting the generated report information to a higher layer entity.

3. The method of claim 2, wherein the report information comprises at least one of information of a server used by the CU-UP, report policy information, and report type information.

4. The method of claim 2, wherein the higher layer entity is an entity relating to at least one of a near real time (RT) radio access network (RAN) intelligent controller (RIC), a near RAN+core network (CN) intelligent controller or a network slice analytics.

5. The method of claim 1, wherein the received information related to the packet transmission comprises at least one of time stamp information generated by the UPF or payload bytes information relating to a packet transmission amount.

6. The method of claim 1, wherein the quality measurement value is a quality measurement value related to packet transmission latency generated based on a local time value of the CU-UP.

7. The method of claim 5, further comprising:
calculating a packet transmission throughput based on the quality measure value and the payload bytes information; and
identifying a quality measurement value for the packet transmission throughput based on the calculated packet transmission throughput.

8. The method of claim 1, further comprising:
receiving a dummy packet generated by the DU from the DU; and
transmitting the received dummy packet to the UPF,
wherein the dummy packet is generated based on the updated packet transmission information.

9. A method performed by an element management system (EMS) entity in a wireless communication system, the method comprising:
transmitting configuration information of information related to packet transmission to a central unit-user plane (CU-UP),
wherein the configuration information of the packet transmission information comprises information related to at least one of a server address indication related to the CU-UP, a report policy indication, or a report type indication.

10. The method of claim 9, further comprising:
transmitting configuration information of quality measurement release to the CU-UP,
wherein the report policy indication indicates at least one of an immediate report policy or a delayed report policy, and
wherein the report type indication indicates whether the CU-UP reports to a higher layer entity.

11. A central unit-user plane (CU-UP) in a wireless communication system, the CU-UP comprising:
at least one transceiver;
at least one processor; and
memory storing instructions that, when executed by the at least one processor, cause the CU-UP to:
receive information related to packet transmission from a user plane function (UPF), the information related to the packet transmission comprising a quality of service (QoS) flow provided, a slice provided with the QoS flow, an indicator indicating a terminal for receiving the QoS flow and a time parameter related to latency quality measurement,
identify a quality measurement value based on the received information related to the packet transmission,
update the received information related to the packet transmission based on the identified quality measurement value, and
transmit the updated information related to the packet transmission to a distributed unit (DU).

12. The CU-UP of claim 11, wherein the instructions, when executed by the at least one processor, cause the CU-UP to:
generate report information based on the updated information related to the packet transmission; and
transmit the generated report information to a higher layer entity.

13. The CU-UP of claim 12, wherein the report information comprises at least one of information of a server used by the CU-UP, report policy information, and report type information.

14. The CU-UP of claim 12, wherein the higher layer entity is an entity relating to at least one of a near real time (RT) radio access network (RAN) intelligent controller (RIC), a near RAN core network (CN) intelligent controller or a network slice analytics.

15. The CU-UP of claim 11, wherein the received information related to the packet transmission comprises at least one of time stamp information generated by the UPF or payload bytes information relating to a packet transmission amount.

16. The CU-UP of claim 11, wherein the quality measurement value is a quality measurement value related to packet transmission latency generated based on a local time value of the CU-UP.

17. The CU-UP of claim 15, wherein the instructions, when executed by the at least one processor, cause the CU-UP to:
calculate a packet transmission throughput based on the quality measure value and the payload bytes information, and
identify a quality measurement value for the packet transmission throughput based on the calculated packet transmission throughput.

18. The CU-UP of claim 11, wherein the instructions, when executed by the at least one processor, cause the CU-UP to:
receive a dummy packet generated by the DU from the DU, and
transmit the received dummy packet to the UPF,
wherein the dummy packet is generated based on the updated packet transmission information.

19. An element management system (EMS) entity in a wireless communication system, the EMS entity comprising:
at least one transceiver;
at least one processor; and
memory storing instructions that, when executed by the at least one processor, cause the EMS entity to:
transmit configuration information of information related to packet transmission to a central unit-user plane (CU-UP), wherein the configuration information of the packet transmission information comprises information related to at least one of a server address indication related to the CU-UP, a report policy indication, or a report type indication, and
transmit configuration information of quality measurement release to the CU-UP,
wherein the report policy indication indicates at least one of an immediate report policy or a delayed report policy, and
wherein the report type indication indicates whether the CU-UP reports to a higher layer entity.

20. The EMS entity of claim 19, wherein the instructions, when executed by the at least one processor, cause the EMS entity to:
transmit configuration information of quality measurement release to the CU-UP,
wherein the report policy indication indicates at least one of an immediate report policy or a delayed report policy, and
wherein the report type indication indicates whether the CU-UP reports to a higher layer entity.
